(19) United States
(12) Patent Application Publication
(10) Pub. No.: US 2024/0011469 A1
(43) Pub. Date: Jan. 11, 2024

(54) SYSTEM AND METHOD FOR GENERATING FORCES USING ASYMMETRICAL ELECTROSTATIC PRESSURE

(71) Applicants: Andrew Neil Aurigema, Oak Hill, FL (US); Charles Raymond Buhler, IV, Merritt Island, FL (US)

(72) Inventors: Andrew Neil Aurigema, Oak Hill, FL (US); Charles Raymond Buhler, IV, Merritt Island, FL (US)

(21) Appl. No.: 18/370,718

(22) Filed: Sep. 20, 2023

Related U.S. Application Data
(63) Continuation-in-part of application No. 18/070,428, filed on Nov. 28, 2022.
Application No. 18/070,428 is a continuation-in-part of application No. 16/688,619, filed on Nov. 19, 2019, now Pat. No. 11,511,891.
(60) Provisional application No. 62/769,415, filed on Nov. 19, 2018.

(51) Int. Cl. F03G 7/00

(52) U.S. Cl. CPC F03G 7/00; F03H 3/00

(57) ABSTRACT

A system and method for generating one or more electrostatic pressure forces or one or more divergence in electric field forces, or both, acting on at least one surface of an object. Asymmetries in the resulting force vectors result in a net resulting force acting on the object. The magnitude of the net resulting force may be a function of the geometry of the object surfaces, the amount of electric charge present on the surfaces, and the dielectric constant(s) of materials present in a gap between the object surfaces. The invention may be produced on a nanoscale using nanostructures such as carbon nanotubes. The invention may be utilized to provide a motivating force to an object. A non-limiting exemplary use case example is the use of electrostatic pressure force apparatus as a propellantless thruster to propel a spacecraft through a vacuum.

### REFERENCE

This non-provisional patent application is a continuation in part of U.S. patent application Ser. No. 18/070,428, entitled “SYSTEM AND METHOD FOR GENERATING FORCES USING ASYMMETRICAL ELECTROSTATIC PRESSURE”, filed in the United States Patent and Trademark Office (USPTO) on Nov. 28, 2022, which published as US 2023-0121805 on Apr. 5, 2020, which is incorporated herein by reference in its entirety; Ser. No. 18/070,428 is a continuation in part of U.S. patent application Ser. No. 16/688,619, entitled “SYSTEM AND METHOD FOR GENERATING FORCES USING ASYMMETRICAL ELECTROSTATIC PRESSURE”, filed in the United States Patent and Trademark Office (USPTO) on Nov. 19, 2019, which published from the USPTO as U.S. Patent Publication No. US 2020-0255167 A1 on Aug. 13, 2020, and which issued as U.S. Pat. No. 11,511,981 on Nov. 29, 2022, which is incorporated by reference herein in its entirety: U.S. patent application Ser. No. 16/688,619 is a non-provisional of, and claims the benefit of priority to, U.S. provisional patent application Ser. No. 62/769,415 titled A PROPELLANTLESS PROPULSION CONCEPT FOR SPACECRAFT BASED ON ELECTROSTATIC FIELD MOMENTUM TRANSFER, filed in the United States Patent and Trademark Office (USPTO) on Nov. 19, 2018, which is also incorporated herein by reference in its entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

### 1. Field of the Invention

The field of the invention relates generally to systems and methods for providing forces on objects in which such forces are generated by voltages, or voltage differences, when such voltages or voltage differences are applied to electrically conductive surfaces in such a way as to generate electrostatic pressure forces on an object. In embodiments, the field of the invention relates to systems and methods that make use of such forces in specific applications or use cases. An exemplary use case, which is but one of many use cases, is the case in which it is desired to provide a motivating force on an object in the case which the object is disposed in a vacuum. The field of the invention further relates to engines for vehicle that operate on principles of applied electric charge or field, for example, but not limited to, engines and thrusters for space vehicles.

### 2. Background Art

The elimination of complex systems, such as, for example, machinery, utilized for the conversion of energy to motion has the potential to provide a great cost savings over, and greatly reduced weight and volume, over the systems of the prior art. The elimination of complex systems for converting energy to motion is especially desirable, for example, in the case of self-propelled vehicles such as spacecraft, aircraft and watercraft. For example, the mass of a body or object to be accelerated is the single largest driving parameter of spacecraft design. For example, in order to motivate a spacecraft through space (i.e., through a vacuum) or maintain its location against external influence such as gravitational forces, spacecraft must carry within themselves all the propellant mass, excitation energy, and mechanical structure to generate physical thrust. As regarding the systems of the prior art, it is only through exhausting high velocity gas that physical momentum may be transferred to a spacecraft. This momentum over time is what accelerates the spacecraft and achieves a desired motion, or motivation, of the spacecraft. Again, as an example, commercial satellites typically reserve 85% or more of their total mass per volume budget for propulsion related activities. That is to say, due to the low efficiency of chemical and/or electrically enhanced chemical propulsion systems, 85% or more of the total weight per volume of a spacecraft is expended in propulsion related activities. A spacecraft's mission capability is therefore determined in large part by the amount of physical thrust that can be extracted from the stored propellant. The total amount of physical thrust available to a spacecraft is determined by the efficiency of the propulsion system and the total amount of propellant stored on the spacecraft. When a spacecraft's stored propellant is expended, the ability to control the path, or maintain precise location, of the spacecraft is brought to an end. Without the ability to react to external forces, the spacecraft ceases to be an asset and becomes a liability. Simply put, spacecraft become space junk when their stored propellant is exhausted.

Since any conversion of energy from one form to another is accompanied by losses due to friction, radiation or conduction of heat, hysteresis, and the like, it is needful that advances in the state of the art be developed that increase the efficiency of producing forces which may be used to motivate an object. It is especially desirable that such advances in the state of the art be in a form that eliminates the need for the use of stored propellant so that vehicles such as, for example and not by way of limitation, spacecraft using such a systems and method could greatly reduce, or even eliminate, their dependency on stored propellant and propellant based propulsion systems. Such advances, if realized, would greatly enhance the present ability to motivate payloads, increase the lifetime of spacecraft and other devices and systems, and thereby enable entirely new uses for such systems. Such advances would enable new systems and methods for providing applied forces for any number of use cases, one example of many, being the motivation of an object. It is an object of the present invention to utilize the energy stored in an electric field, or fields, to provide such applied forces.

The notion of using electric fields as a method of propulsion was previously explored as far back as the 1920's by, for example, Thomas Townsend Brown (“Brown”). Brown discovered that a force was developed on a Coolidge tube when the tube was subjected to a high voltage. His electric field force effect is an electrical phenomenon, which employs an electric field for generating applied forces, which could be used, for example, to motivate a spacecraft without exhausting propellant. As disclosed in U.S. Pat. No. 2,949,550 [Brown 1957] and U.S. Pat. No. 3,187,206 [Brown 1958], as an “electrokinetic” phenomenon, electrical energy can be converted to mechanical energy which is then used to provide a force for providing movement to a structure. There were several patents describing propellentless propulsion devices based on this effect coined the “Biefeld-Brown Effect” named after Brown and his graduate school advisor, Dr. Paul Alfred Biefeld. Brown and Biefeld were U.S. Pat. No. 2,949,550 [Brown 1957], U.S. Pat. No. 3,018,394 [Brown 1957a], and U.S. Pat. No. 3,187,206 [Brown 1958] for devices based on utilization of the effect. Brown's colleague A. H. Bahnson was similarly issued U.S. Pat. No. 2,958,790 [Bahnson 1958], U.S. Pat. No. 3,223,038 [Bahnson 1965], and U.S. Pat. No. 3,227,901 [Bahnson 1966] utilizing the effect.

There has been recurring interest in these devices since the work of Brown. In one configuration, two asymmetrical capacitors are arranged to rotate about a vertical axis, termed Asymmetrical Capacitor Thruster (ACT). Another common configuration involves one capacitor plate of a capacitor plate pair being disposed above its mate, arranged so the device can lift off of the ground. This device is called a lifter. Alexander de Seversky investigated lifters during the 1960's with his “Ionocraft” and received a U.S. patent [Seversky, 1964]. De Seversky's craft combined a series of wires perpendicular to a mesh plate to lift the device. J. L. Naudin and others have constructed devices similar to the original Brown patent, and then assembled multiple devices into larger designs to create “lifters” that perform similarly to de Seversky's craft. These designs vary greatly in size and shape; some are comprised of multiple cells, or comprise stacked layers of cells, to create more efficient and more powerful devices. Other such devices are disclosed in U.S. Pat. No. 6,492,784 to Hector Serrano [Serrano 2002], which generates the Biefeld-Brown Effect using stacked-disc asymmetrical capacitors.

NASA also has investigated the use of Brown's discovery. Jonathan Campbell of NASA's Marshall Space Flight Center has designed and tested ACTs that use dielectrics to increase their thrust, receiving U.S. patents for this work in 2001 and 2002 as disclosed in U.S. Pat. Nos. 6,317,310, 6,411,493, and 6,775,123 [Campbell 2001, 2002, and 2003].

Thomas Bahder and Chris Fazi [Bahder and Faze 2002] of the Army Research Lab (ARL) in Adelphi, MD have also reported work on the subject. They constructed multiple devices, both original and reproductions of designs found on the internet and made qualitative observations. Bahder and Fazi's paper includes a brief history and an attempt at an explanation of the cause of the force observed. However, they conclude that “At present, the physical basis for the Biefeld-Brown effect is not understood.”

An early test of this effect in vacuum was performed by Robert Talley [Talley et al., 1991] of Veritay Technology performed in the late 1980's under an Air Force contract. Talley suspended a sphere-disk ACT from a suspension wire and measured torsion forces on it. This gave him the sensitivity to be able to measure small forces. This lengthy report is one of only two written on this effect describing a measurement of a force while in a vacuum chamber. Talley ultimately attributed the force that he observed to the electrostatic interaction between the chamber and the device. Talley wrote, “Direct experimental results show that under high vacuum conditions . . . no detectable propulsive force was electrostatically induced by applying a static potential difference . . . between test device electrodes . . . ” Talley concluded (page 91 of his report), “If such a force still exists and lies below the threshold of measurements in this program, then the force may be too small to be attractive for many, if not most, space propulsion applications.” While this work makes a strong case against the ability of these devices to produce a force in a vacuum, it did not address the use of asymmetrical capacitors in the atmosphere.

Follow-on work was performed by NASA to evaluate the technology. A comprehensive review of the current state of the art can be obtained from Canning, Francis X., Melcher, Cory, and Winet, Edwin, Asymmetrical Capacitorsfor Propulsion, Glenn Research Center of NASA (NASA/CR-2004-213312), Institute for Scientific Research, October, 2004. Canning [2004] showed that a majority of asymmetrical capacitors (ACTs) exhibit a null thrust unless there is an accompanying ion wind. They performed tests on cylindrical-disk geometries under applied voltage in a vacuum bell jar and concluded that there were no forces produced in a vacuum. They find that their operation is “fully explained by a very simple theory that uses only electrostatic forces and the transfer of momentum by multiple collisions”.

Nearly all patents described above include an electrode at a high voltage in air, the consequence of which is that the air is ionized as electrons are stripped from its gas molecules. Once the gas ions are charged, they will traverse toward the electrode of the opposite polarity as directed by the field. This current is known as corona current. These gas ions bombard other neutral gas ions which in turns produces a net movement on the gas which is normally ˜1 m/s. Since these thrusters are comprised of an asymmetry of the electrical field there is only one direction of gas movement emanating from the sharp electrode to the dull electrode. The sharp electrode creates a higher electric field locally which ionizes the gas whereas the dull electrode does ionize the gas. This asymmetry gives rise to the direction of the wind regardless of the polarity of the electrodes. In all cases, momentum is conserved by having a net ion wind in one direction, and the momentum on the asymmetrical capacitor in the opposite direction. There are applications that take advantage of this effect, such, for example, devices such as lifters. In 2018, Professor Steven Barrett of MIT made headlines by building a horizontal aircraft fly across a gym with no moving parts using ion wind thrust [Xu et al., 2018] and spoke at a recent Electrostatics Society of America conference on the subject.

Many of the above patents make no reference to ion-wind effects; and, experimenters, including Brown, do not mention methods to mitigate this well-known ion-wind effect. As a result, many authors who test asymmetrical capacitors believe the force they observe will have some use either in space or for large aircraft, both of which are impossible for ion-wind versions. Therefore, the current state of the art of the use of electrical energy for the direct production of linear force and motion is through ion wind propulsion or one of the two technologies mentioned below.

The most current example of a propellantless field propulsion system is an electromagnetic drive system as disclosed in British Patents GB2229865, GB2334761, GB2399601 and UK Patent Application GB2537119 to Shawyer, as well as U.S. Pat. Appl. No. 20140013724 to Fetta. This system includes an axially-asymmetric resonant cavity with a conductive inner surface adapted to support a standing electromagnetic (EM) wave. The resonating cavity lacks second-axis axial symmetry, thereby causing the standing EM wave to induce a net unidirectional force on the resonant cavity, thus generating thrust without reaction mass. Experimental versions of these EM devices have reportedly produced thrust levels of micro-newtons up to milli-newtons from several kilowatts of input power (AIAA Journal of Propulsion and Power, op.cit.).

Field modification approaches to propellantless propulsion include apparent reductions in gravitational mass or inertial mass. U.S. Pat. No. 3,626,605 to Wallace discloses a method and apparatus for generating a time-variant non-electromagnetic force field due to the relative motion of moving bodies constituted of elements whose nuclei have half integral “spin” values, with said force field exhibiting itself in the form of an induced secondary gravitational force. U.S. Pat. No. 5,280,864 to Woodward in 1994 discloses a method for producing transient fluctuations in the inertial masses of material objects by employing an effect that is a consequence of relativistic theories of gravitation. This patent is a continuation in part of application Ser. No. 07/521,992 filed in 1990 as CIP of U.S. application Ser. No. 07/031,157 filed in 1987 as CIP of application 6/919,647 filed in 1986, now all abandoned. The patent basically uses high frequency vibrating piezoelectric force transducers to accelerate a capacitor array while applying high frequency AC to electrically oscillate ions in the dielectrics. The relativistic Mach Effect was predicted to produce unidirectional forces.

In subsequent U.S. Pat. Nos. 6,098,924, 6,347,766 and 9,287,840, Woodward disclosed various improvements to the device of U.S. Pat. No. 5,280,864 for producing propellantless thrust by using piezoelectric force transducers attached to resonant mechanical structures, in accordance with Mach's principle and local Lorentz-invariance predictions of transient rest mass fluctuations in accelerated objects. The device was designated the “Mach Effect Thruster”. The latest U.S. Pat. No. 9,287,840 in 2016 incorporates acceleration and temperature feedback sensors in the electronics control system, uses a DC bias voltage superimposed on the high frequency the AC voltages to activate transducers, and applies pulsed AC waveforms. With these improvements, the device produced 6-7 micro-newtons of thrust with a 100 W power input, which is approximately 14 megawatts/Nt. The disclosure admits that the device is not scalable and that arrays of multiple small devices would be necessary to generate larger thrusts.

In U.S. Patent Application Publication No. 2006/0065789, Woodward introduced his “flux capacitor” which proposed modifications to the devices of U.S. Pat. Nos. 5,280,864, 6,098,924, and 6,347,766 to overcome a serious internal propagation speed problem. The force transducers were eliminated, and the capacitor arrays were either enclosed within induction coils or external induction coils were aligned with axes perpendicular to the displacement fields in the capacitor. The objective was to replace transducer accelerations by using induction coils to generate perpendicular magnetic field oscillations of the dielectric ions.

None of the above described systems or methods satisfy the stated need in the art.

### BRIEF SUMMARY OF THE INVENTION

The present invention comprises an apparatus and method that have one or more of the following features and/or steps, which alone or in any combination may comprise patentable subject matter.

Generally, the system and method of the invention satisfies the stated need in the art by generating a force usable for any purpose, such as, by way of example and not by limitation, thrust, motivating force or actuation, without the use of any expelled propellant, or any propellant at all. The system and method of the invention takes advantage of an aspect of the conservation of momentum for electromagnetic systems in a novel way, in which a net force is generated on a system or object by imbalances of electrostatic pressure. This “Electrostatic Pressure Force” (EPF) has been thoroughly tested by the inventors and has been verified repeatedly in a laboratory environment using a variety of independent configurations for the system of the invention.

In accordance with one embodiment of the present invention, the invention comprises an apparatus for generating a force on an object, comprising an object that comprises at least one surface, wherein an electric charge or electric field, or both, is/are applied to said at least one surface, or to at least one region of the at least one surface. The application of the electric charge or electric field to the at least one surface or at least one region of the at least one surface may give rise to an electrostatic pressure acting on the at least one surface or at least one region of the at least one surface of the object, thereby generating an electrostatic pressure force on the at least one surface or at least one region, or both. The electrostatic pressure force acting on the at least one surface, or at least one region of the at least one surface, may be characterized by a net resulting electrostatic pressure force acting on the object. In embodiments, the at least one surface, or the at least one region of the at least one surface, may be further defined as a plurality of surfaces, each surface possibly having one or a plurality of regions, each surface and/or region experiencing an electrostatic pressure force proportional to the amount of electric charge on the surface or region, or the magnitude of the applied electric field to each surface or region, or both; the electrostatic pressure force acting on the surface or region having a vector that may also be determined by the three-dimensional shape and size of the surface or region. The vector sum of each of the electrostatic pressure forces on each of the surfaces and/or regions may result in at least one net resulting electrostatic pressure force acting on the object.

The three-dimensional shape of the object may be any shape as determined by the user to produce at least one desired net resulting force from one or more Electrostatic Pressure Force(s) in accordance with the principles of the invention. The object's shape, size and material composition may be as simple or as complex as determined by a user to achieve produce at least one desired net resulting force from one or more Electrostatic Pressure Force(s) in accordance with the principles of the invention.

Generally, the at least one net resulting force acting on the object is the vector sum of all of the Electrostatic Pressure Force(s) acting on each surface of the object. The surfaces may comprise the outer surface of the object. Each surface of the object may, or my not, comprise regions. Some or all of the surfaces, and the optional regions within a surface, may, or may not, be in electrical communication with one another, as determined by a user to achieve at least one desired net resulting force acting on the object. For example, if where desired by a user to apply an uniformly distributed electric charge across two surfaces, the user may elect to electrically connect those two surfaces in order to achieve a uniform electric charge distribution across them. On the other hand, in a case in which the user desires to achieve a first electric charge per unit area on a first surface, and a second electric charge per unit area on a second surface, where the first electric charge per unit area and the second electric charge per unit area are not equal, the user may elect to electrically isolate the first surface from the second surface. And so on, for any number of surfaces and any number of regions with the surfaces of the object.

The magnitude and direction of the electrostatic pressure force acting on any surface or region of the invention may be achieved by determining one or more parameters selected from the group consisting of. 1) the amount of electric charge on the surface or region; 2) the magnitude and direction of any electric field acting on the surface or region; 3) the three-dimensional shape of the surface or region; or 4) the size of the surface or region. The foregoing parameters may be determined in any combination in order. Thus these parameters may be determined by the user, in accordance with the inventive principles set forth herein, such that at least one desired electrostatic pressure force acting on a surface or region of the invention is achieved, and when the object comprises a plurality of surfaces or regions of surfaces, at least one net resulting force acting on the object is achieved.

In embodiments, it is not necessary that the at least one electric charge be evenly distributed across all surfaces, or regions of surfaces, of the object. Said another way, there may be one or more surfaces or regions of the surface(s) of the object that comprise an electric charge having a first value, one or more surfaces of regions of the surface(s) of the object that comprise an electrical charge having a second value, one or more surfaces or regions of the surface(s) of the object that comprise an electrical charge having a third value, for any number of regions, and any number of difference electrical charges or electric fields applied the regions. It is not necessary that all surfaces or regions of the surface(s) of the object have a non-zero value of electrical charge (such regions may have zero electric charge). Surfaces, or regions surfaces, of the object that have different values of electric charge may have any value, of gradation of electric charge at the boundaries between them as may be determined by the user, so as to achieve any desired net force(s) acting on the object, in accordance with the inventive principles described herein.

In embodiments, it is not necessary that the surfaces of the object be electrically conductive. In other words, the surfaces of the object may or may not be electrically conductive. The surfaces of the object may, for example, comprise any material or combination of materials, which may include electrically conductive materials such, for example metals, electrically insulating materials, dielectric materials or any other material compositions. Further, the material composition of the object does not necessarily need to be homogenous across all surfaces of the object. Thus, surfaces and regions of the object may comprise electrically conductive or non-electrically conductive surfaces, in any size or shape, in any combination or order, as may be determined by the user to achieve any desired net resulting force(s) acting on the object, in accordance with the inventive principles described herein.

In accordance with one embodiment of the present invention, the invention comprises an apparatus for generating at least one force on an object, comprising: an object that comprises at least one electrode having at least one electrically conductive surface, wherein at least one electrical charge is applied to said at least one electrically conductive surface. The application of said at least one electrical charge to said at least one electrically conductive surface generates an electric field, giving rise to an electrostatic pressure acting on the at least one surface of said object, thereby generating a electrostatic pressure force on the at least one surface. The electrostatic pressure force may be characterized by a net resulting electrostatic pressure force acting on the object.

In embodiments, the net resulting electrostatic pressure force may be characterized as being defined by a vector that is the vector sum of all electrostatic pressure forces acting on the object.

In embodiments, the net resulting pressure force may be characterized as acting on a center of mass of the object, thus propelling the object along a desired vector

In any of the embodiments, the net resulting pressure force may not act on or through a center of mass of the object. In such cases, the net resulting pressure force may impart a rotational force on said object, having components in any or all of the axes of a three-dimensional coordinate space, thus steering the object.

In embodiments, electric charge of the same or differing values may be applied to the various surfaces, and regions of surfaces, of the object, at times, and in amounts, so as to propel and/or to steer a vehicle to which the object, or a plurality of objects, is attached. In embodiments, the application of electric charge or applied electric field to the various surfaces and regions of surfaces of one or more objects may be controlled by algorithms carrying out the computational methods described herein, the algorithms contained in non-transitory computer readable instructions contained in non-transitory computer readable media in communication with a processor or controller, where the processor or controller reads and executes the computer readable instructions for carrying out the functions of the invention (i.e., controls the application of electric charge or applied electrical field to each surface or region of the one or more objects, so as to achieve one or more net resulting electrostatic pressure forces acting on the object. The controller or processor may be in communication with, or may contain, controllable sources of electric field or electrical charge generation that are, in turn, in electrical communication with the surfaces and regions of the object, such that a computationally determined amount of electric charge or applied electric field (or both) are applied to the various surfaces of the object, and/or regions of surfaces, of the object, or plurality of objects, such that one or more net resulting propelling forces or rotational forces on the object result, the magnitude of such forces being variable over time as controlled by the controller or processor, in order to propel and/or steer a vehicle to which the object or plurality of objects is attached at a desired thrust and in a desired direction. Thus, the object or plurality of objects may form a propellantless engine, useful for propelling a vehicle, or any structure, along a desired vector, controllable for amount of thrust and direction, using only an controllable electric charge or electric field, applied to one or more surfaces or regions of the one or more objects.

In embodiments, the shape and geometric arrangement of the surfaces and regions of surface charge of the object, and the value of the at least one electrical charge applied to the surfaces and regions of the object, may each be defined by computational methods to achieve a desired net resulting electrostatic pressure force acting on the object.

In accordance an embodiment of the present invention, the invention comprises an apparatus for generating a force on an object, comprising an object having a plurality of surfaces, each of the surfaces being attached to one another by non-electrically conductive means; wherein an electric charge may be applied to two or more of the surfaces, each of the surfaces receiving a different voltage, thus creating an electric charge difference as between the surfaces, wherein the electric charge difference generates an electric field giving rise to an electrostatic pressure acting on at least one surface of the object, thereby generating an electrostatic pressure force on said at least one surface of the object; and wherein the electrostatic pressure force is characterized by a net resulting electrostatic pressure force acting on said object. The surfaces may be, but are not necessarily, electrically conductive surfaces, and may each comprise regions that have differing levels of electric charge in each region, or no charge at all.

In an embodiment, the net resulting electrostatic pressure force may be characterized as being the vector sum of all electrostatic pressure forces acting on the surfaces, and regions of surfaces of the object, and the net resulting electrostatic pressure force may be characterized as acting on said object along an axis.

In an embodiment, the size, shape and geometric, in other words, the three-dimensional, arrangement of the surfaces of the object and the value of the any electric charge applied to one or more of the surfaces may each be defined by computational methods to achieve a desired net resulting electrostatic pressure force acting on the object, in accordance with the principles of the invention. The surfaces may be, but are not necessarily, electrically conductive surfaces.

In an embodiment, the plurality of surfaces may be further defined as at least one set of opposing surfaces, wherein each of the set of opposing surfaces comprises a first surface and an opposing second surface; wherein said electric charge is further defined as a first electric charge and a second electric charge, each of said first electric charge and said opposing second electric charge having a different value, forming an electric charge difference as between them; wherein said first electric charge is applied to said first surface, and said second electric charge is applied to said second surface, causing an electric field to be generated between said first surface and said conductive surface. The surfaces may be, but are not necessarily, electrically conductive surfaces.

In an embodiment, the first surface may comprise at least one proximal surface and at least one distal surface, the at least one proximal surface being in closer proximity to the second surface than the at least one distal surface. The surfaces may be, but are not necessarily, electrically conductive surfaces.

In an embodiment, the invention may further comprise further an surface that extends from the at least one proximal surface distal surface to the at least one proximal surface proximal surface. The surfaces may be, but are not necessarily, electrically conductive surfaces.

In an embodiment, the second surface may be further defined as comprising a flat planar surface.

In an embodiment, the at least one proximal surface and at least one distal surface may further be defined as a plurality of proximal surfaces and a plurality of distal electrically, respectively.

In an embodiment, the at least one set of opposing surfaces may be further defined as a plurality of sets of opposing surfaces, resulting in at least one net resulting electrostatic pressure force equaling the vector sum of the electrostatic pressure forces generated by the electrostatic pressures operating on the surfaces of the object, the at least one net resulting electrostatic pressure force acting on the object. The surfaces may be, but are not necessarily, electrically conductive surfaces.

In an embodiment, each set of opposing surfaces may be aligned along an axis that is collinear with the vector of each of the resulting net electrostatic pressure force, such that each of the resulting net electrostatic pressure forces is summed into a total net electrostatic pressure force acting on the body along the axis. The surfaces may be, but are not necessarily, electrically conductive surfaces.

In an embodiment, the distal surface, the surface extending from the distal surface to the proximal surface, and the proximal surface may form a blade configuration. The surfaces may be, but are not necessarily, electrically conductive surfaces.

In an embodiment, each of the first electrically conductive surfaces comprises a plurality of electrically conductive proximal surfaces and a plurality of electrically conductive distal surfaces, wherein each electrically conductive proximal surface may be in electrical communication with at least one electrically conductive distal surface by an electrically conductive surface extending from the at least one electrically conductive distal surface to the electrically conductive proximal surface.

In an embodiment, each of the first electrically conductive surfaces of each set of electrically conductive surfaces may comprise a plurality of electrically conductive proximal surfaces and a plurality of electrically conductive distal surfaces, wherein each electrically conductive proximal surface is in electrical communication with at least one electrically conductive distal surface by an electrically conductive surface extending from said at least one electrically conductive distal surface to said electrically conductive proximal surface.

In an embodiment, each of the electrically conductive surfaces may comprise at least one carbon nanotube.

In an embodiment, each of the electrically conductive surfaces may comprise a plurality of carbon nanotubes.

In an embodiment, the electric charge may be time-varying.

In an embodiment, the invention may comprise an electrostatic pressure force thruster for a vehicle, comprising:
an object structure comprising a plurality of electrically conductive surfaces, each of said electrically conductive surfaces attached to one another by non-electrically conductive means, said object structure adapted to be attached to a vehicle having a center of mass;
wherein an electric charge is applied to two or more of said electrically conductive surfaces, each of said electrically conductive surfaces receiving a different value of electric charge, thus creating an electric charge difference as between the electrically conductive surfaces;
wherein the electric charge difference generates an electric field giving rise to an electrostatic pressure acting on at least one surface of said object, thereby generating an electrostatic pressure force on said at least one surface of said object;
giving rise to a net resulting electrostatic pressure force characterized as having a vector that is the vector sum of all the electrostatic pressure force acting on surfaces of the object;
wherein said resulting net electrostatic pressure force motivates said vehicle to which said structure is attached when said voltages are applied to said electrically conductive surfaces.

The net resulting electrostatic pressure force may pass through the center of mass of said vehicle.

In an embodiment, the invention may comprise a method for generating a force on an object, comprising the steps of
a. Providing an object having at least one surface, which may be, but is not necessarily, electrically conductive; and
b. Generating an electrostatic pressure on at least one surface of said object by applying an electric charge to the at least one surface, said electric charge generating an electric field, the electric field giving rise to an electrostatic pressure acting on said at least one surface, or, by applying an electric field to the at least one surface, thereby generating a electrostatic pressure force on said at least one surface, wherein the electrostatic pressure force acts on said object.

In embodiments, the at least one surface, or at least one region of a surface, may be electrically conductive or non-electrically conductive.

In an embodiment, the method of the invention may be further defined as the object comprising a plurality of surfaces, each of the surfaces having an applied electric charge, or being subject to, an applied electric field, or both, the at least one net resulting electrostatic pressure force(s) on the object being characterized as being the vector sum of all electrostatic pressure forces acting on said object.

In an embodiment, the at least one surface may be further defined as two opposing surfaces, and wherein said at least one electric charge is further defined as a first electric charge and a second electric charge, said first and said second electric charge are of different value such that together they form an electric charge difference between them, and wherein the first electric charge is applied to said first conductive surface, and the second electric charge is applied to the second conductive surface.

In an embodiment, a method of the invention may further comprise the step of using a computational method to determine the size, three-dimensional shape and geometric arrangement of the at least one surface(s) of the object, and to determine the value of the at least one applied electric charge or electric field, so as to achieve at least one desired net resulting electrostatic pressure force acting on the object when all the electrostatic pressure force acting on the surfaces of the object are vector summed, wherein the computational method comprises the steps of:
a. defining at least one desired net resulting electrostatic pressure force;
b. defining the size, three-dimensional shape, and arrangement of each of the at least one surface, or the at least one region of each surface of the at least one surface, of the object;
c. selecting an initial value for said at least one electric charge, or electric field, or both, to be applied to each surface of the the at least one surface, or each region of the at least one region of each surface of, of the object;
d. determining the resulting electric field intensity at each point along each surface of the at least one surface, or each region of the at least one region of each surface of the at least one surface, of the object;
e. determining the resulting electrostatic pressure force acting on each surface of the at least one surface, and on each region of the at least one region of each surface of the at least one surface, of the object;
f. summing, in vector fashion, all resulting electrostatic pressure forces acting on each of surface of the at least one surface and on each region of the at least one region of said object to determine at least one computed total net resulting electrostatic pressure force acting on said object;
g. comparing the computed total net resulting electrostatic pressure force to the at least one desired net resulting electrostatic pressure force for acting on said object; and
h. iteratively changing the size, three-dimensional shape or three-dimensional arrangement, or both, of one or more of the surfaces of the at least one surface, or of one or more of the at least one regions, or both, or changing the value of the electric charge or electric field, or both, applied to one or more surfaces or regions of the at least one surface or at least one region, and repeating steps c.-f. until the desired at least one net resulting electrostatic pressure force acting on said object is achieved
i. wherein each of the surfaces and regions may be, but are not necessarily, electrically conductive.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The figures of the drawings are not necessarily to scale. The drawings are only for the purpose of illustrating exemplary embodiments of the invention and are not to be construed as limiting the invention. In the drawings:

FIG. 1A depicts an exemplary, non-limiting embodiment of the invention comprising a single electrode.

FIG. 1B depicts an electric field, depicted by field electric lines 1000, generated by the application of a voltage to the electrically conductive surfaces of the exemplary, non-limiting embodiment of the invention depicted in FIG. 1A.

FIG. 2 depicts an exemplary, non-limiting embodiment of the invention comprising two electrodes, each electrode having electrically at least one electrically conductive surface, in which the electrically conductive surfaces of the electrodes are opposing, and which the first electrode has proximal and distal electrically conductive surfaces.

FIG. 3 depicts a side view of an exemplary, non-limiting embodiment of the invention in form of an object comprising a plurality of electrodes, that are not connected with one another via an electrically conductive medium, suspended between an outer electrode pair, where the outer electrode pair comprises a first electrode 101 and a second electrode 102, in which an electric charge difference is applied across the first electrode and the second electrode, creating an electric field between them, and thereby causing x-axis oriented asymmetrical electrostatic pressure force to develop on each electrode. The-axis oriented asymmetrical electrostatic pressure force on each electrode vector sums to a net resulting electrostatic pressure force on the object.

FIG. 4 depicts a top view of a non-limiting exemplary embodiment of a single-stage electrostatic pressure force apparatus of the invention comprising first and second opposing electrically conductive surfaces, in which the first electrically conductive surface further comprises a blade configuration.

FIG. 5 depicts a perspective view of a non-limiting exemplary embodiment of a single-stage electrostatic pressure force apparatus of the invention comprising first and second opposing electrically conductive surfaces, showing parameters of the geometric arrangement of the electrically conductive surfaces.

FIG. 6A depicts a schematic top view of a non-limiting exemplary embodiment of a single-stage electrostatic pressure force apparatus of the invention, in which various aspects of the electric field intensity are depicted.

FIG. 6B depicts a plot of the electric field, depicted by field electric lines 1000, as seen from the top, for the non-limiting exemplary embodiment of a single-stage electrostatic pressure force apparatus of the invention shown in FIGS. 4, 5 and 6A.

FIG. 7 depicts a schematic top view of a non-limiting exemplary embodiment of a single-stage electrostatic pressure force apparatus of the invention, in which various aspects of electrostatic pressure forces caused by the electric field are depicted.

FIG. 8 depicts a coordinate axis for reference in all the figures of the drawings.

FIG. 9 depicts a side view of a non-limiting exemplary embodiment of a multi-stage electrostatic pressure force apparatus of the invention.

FIG. 10 depicts a side view of a non-limiting exemplary embodiment of a multi-stage electrostatic pressure force apparatus of the invention, in which the polarity of the applied voltage differential is shown, is may be the case in some embodiments, as alternating between stages.

FIG. 11 depicts a schematic side view of a non-limiting exemplary embodiment of a multi-stage electrostatic pressure force apparatus of the invention, in which various aspects of the electric field intensity are depicted.

FIG. 12 depicts a schematic side view of a non-limiting exemplary embodiment of a multi-stage electrostatic pressure force apparatus of the invention, in which various aspects of electrostatic pressure forces caused by the electric field are depicted.

FIG. 13 depicts a side view of a non-limiting exemplary embodiment of a single-stage electrostatic pressure force apparatus of the invention that comprises a plurality of proximal surfaces.

FIG. 14 depicts a side view of a non-limiting exemplary embodiment of a single-stage electrostatic pressure force apparatus of the invention that comprises a plurality of proximal surfaces, in which various aspects of the electric field intensity are depicted.

FIG. 15 depicts a side view of a non-limiting exemplary embodiment of a single-stage electrostatic pressure force apparatus of the invention that comprises a plurality of proximal surfaces, in which various aspects of electrostatic pressure forces caused by the electric field are depicted.

FIG. 16 depicts a perspective view of a non-limiting exemplary embodiment of a single-stage electrostatic pressure force apparatus of the invention that comprises a plurality of proximal surfaces that was built and tested as an exemplary test article.

FIG. 17 depicts a non-limiting exemplary embodiment of a multistage force apparatus of the invention in which each first electrode comprises a plurality of proximal and distal electrode surfaces.

FIGS. 18-20 depicts various non-limiting exemplary embodiments of the invention in which at least one intermediate electrode is disposed between two electrodes which are subjected to a voltage difference, forming an electric field causing the intermediate electrode to be electrically polarized, and causing the generation of net resulting electrostatic pressure forces to be generated on the surfaces of the electrodes, resulting in a total net resulting electrostatic pressure force acting on the body of the invention.

FIG. 21 depicts a perspective view of an exemplary test article used to prove the inventive concepts of the present invention.

FIG. 22 depicts a graphical depiction of the forces measured in a test article representing an embodiment of the invention.

FIGS. 23A and 23B depict a graphical representation of the forces measured on an epoxy field test article of an embodiment of the invention (FIG. 23A) and also provides a plot of the net resulting force for an embodiment of the invention is a function of and applied electric charge difference (FIG. 23B).

FIG. 24 depicts a graphical representation of the electric field lines generated by an applied electric charge difference that has been applied across electrodes of a multi-bladed embodiment of the invention, as determined by a computational method of the invention.

FIG. 25 depicts a graphical representation of a net resulting force generated by an electrostatic pressure force apparatus of the invention plotted as a function of spacing between electrodes, as determined by a computational method of the invention.

FIG. 26 depicts a side view of an embodiment of the invention in which the ground plane comprises at least one, and alternatively a plurality, of triangular protuberances.

FIG. 27 depicts a graphical representation of the net resulting force of embodiments of the invention comprising various numbers of equally spaced triangles, as determined by a computational method of the invention.

FIG. 28 depicts a graphical representation of the net resulting force generated by an electrostatic pressure force apparatus of the invention as a function of gap distance, as determined by a computational method of the invention.

FIG. 29 depicts a composite view of three exemplary types of carbon nanotubes which may be used to form electrode surfaces of embodiments of the invention.

FIGS. 30 and 31 depict embodiments of the invention comprising apparatuses for generating one or more forces using a divergent electric field.

FIG. 32 depicts a view of an embodiment of an object of the invention, for the purposes of showing and describing the principles of the invention, and to convey that the embodiments depicted in the other figures are merely exemplary in nature and are thus non-limiting, and are but a few of many embodiments of the invention.

### DETAILED DESCRIPTION OF THE INVENTION

The following documentation provides a detailed description of the invention.

Although a detailed description as provided in the attachments contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention. Thus the scope of the invention should be determined by the appended claims and their legal equivalents, and not merely by the preferred examples or embodiments given.

As used herein, when any two or more structures or elements are described as being “attached by non-electrically conductive means”, or “attached by non-electrically conductive structure”, these phrases include within their meaning any attaching structure or force, or any combination of attaching structures or forces, of any shape or comprised of any material or combination of materials, that attaches the two or more structures or elements, or affixes the spatial relationship between the structures or elements, without providing electrical conductivity between the two or more structures or elements. “Attached by a non-electrically conductive means” or “attached by non-electrically conductive structure” includes within their meaning, but are not limited to, a fixed attachment which does not allow the attached structures to translate or rotate relative to one other, and it includes within its meaning non-fixed attachment which may allow translation or rotation of the attached structures relative to one another. “Attached by non-electrically conductive means” or “attached by non-electrically conductive structure” also includes within their meaning the use of a force or forces to fix the spatial relationship of the structures or elements which are attached, such as, for example and not by way of limitation, the use of magnetic fields to hold electrodes of the invention in a specific spatial relationship. Thus, rotating attachment and sliding attachment are including within the meaning of “attached by a non-electrically conductive means” or “attached by non-electrically conductive structure”. Thus, for example and not by way of limitation, the attaching structure or attaching structures may comprise a combination of electrically conductive and electrically non-conductive materials, or may comprise only non-conductive materials; may comprise a combination of structures or forces; may take any shape; or may comprises any combination of attaching structures or forces, or both, that fix or attach the two structures or elements relative to one another and does not provide electrical conductivity between the two structures or elements.

As used herein, “object” and “body” have the same meaning.

As used herein, “conductive” includes within its meaning “electrically conductive”.

As used herein, “dielectric” and “dielectric material” include within their meaning materials in any state including solid state, liquid state and gaseous state.

As used herein, “electrode” includes within its meaning an element comprising at least one electrically conductive surface. An electrode may be energized by the application of a voltage to the electrode, typically from a voltage source in electrical communication with the electrode, for example, but not necessarily via a conductor, and different electrodes may be energized by the application of different voltages, which may be electrostatic or time-varying, for the purpose of establishing an electric field between two or more electrodes.

As used herein, “electrostatic” means non-time varying. As an example, an applied electrostatic voltage or electric charge is an applied voltage or electric charge that does not vary with time.

As used herein, “geometric arrangement” and “spatial arrangement” include within their meaning the size, orientation and geometric, or three-dimensional shape of the surfaces of an object and it also includes within its meaning the spatial orientation and distance relationship(s) between the surfaces of two or more objects, including the distance between surfaces of the two or more objects, i.e. between the surfaces of one object and the surfaces of another object, and the orientation of the two or more objects and, accordingly, their surfaces, in relation to a common coordinate axis system. In other words, as regards two or more objects, the geometric arrangement between the two or more objects defines the spatial relationship between the each of the surfaces of two or more objects as between the objects, and as regards a single object, the geometric arrangement of the surfaces of an object defines the spatial relationship between the surfaces of that object.

As used herein, “EPF” means electrostatic pressure force.

Theory of Operation of the Invention

In embodiments, the present invention may make use of Conservation of Energy for a center-of-mass (CM) system in which the total energy (kinetic plus potential) is zero. The kinetic energy of a system is comprised of an object with mass M, velocity v with potential energy U is written as:

$$0 = \frac{1}{2} {Mv}^{2} + U \qquad ( 1 )$$

What follows is a method to determine the conservation of momentum similar to the formalisms of Kirk McDonald [McDonald 2002] where one simply solves for momentum to give:

$$Mv = - \frac{2}{v} U \qquad ( 2 )$$

Now we simply turn the velocity in the denominator of (2) into its operator

$$v = \frac{dx}{dt}$$

to give

$$Mv = - \frac{2 Udt}{dx} . \qquad ( 3 )$$

The next step is to note that d(Ut)=Udt+tdU and solving for Udt=d(Ut)−tdU. The differential of the product of energy and time is akin to the differential of the energy-time action integral S=∫L dt of the Lagrangian. Nature chooses the path of least action which is found by setting the differential to zero δS=δ∫Ldt=0. Here we make the claim that the differential of the energy-time product should also be set to zero d(Ut)=δ(Ut)=0 meaning

Udt=−tdU (4)

Putting this back in to (3) becomes

$$Mv = + 2 t \frac{dU}{dx} \qquad ( 5 )$$

There are other ways to derive this equation but it is well known that Force is the time rate of change of momentum and is also the spatial derivative of energy with distance.

The next step is to fill in the potential energy of the system. Conventionally one uses an external field as a source of the potential. However, we use a more generic form of energy, the energy stored in the field. In particular the energy stored in the electric field given by

$$U = \frac{{ε}_{o}}{2} \int {E}^{2} d τ \qquad ( 6 )$$

a well-known equation. The placement of (6) into (5) along the x direction gives

$$M v = {ε}_{o} t \frac{d}{d x} \int \int \int {E}^{2} dxdydz \qquad ( 7 )$$

$$= {ε}_{o} td ( \int \int {E}^{2} d y d z ) \qquad ( 8 )$$

$$= {ε}_{o} t Δ ( {E}^{2} A ) \qquad ( 9 )$$

which can be written as

P(t)=Mv=εₒt[E₂²A₂−E₁²A₁] (10)

Equation (10) shows a linear time dependence on the momentum with a corresponding force of

$$F = \frac{d P}{dt} = {ε}_{o} [ {E}_{2}^{2} {A}_{2} - {E}_{1}^{2} {A}_{1} ] \qquad ( 11 )$$

if the electric field does not have a time dependence (electrostatic). Equation (11) is remarkable because it shows that a system (or object) can experience a net resulting electrostatic pressure force F if there are asymmetries in the electrostatic pressure experienced by (i.e. acting on) the surfaces of the object, for instance, such that the vector sum of the electrostatic pressure force acting on the surfaces of the system (or object) is non-zero. The determination of the electric field strength at any point along the surfaces of the system (or object), the resulting electrostatic pressure and electrostatic pressure force acting on the surfaces of the objected, and the net resulting electrostatic pressure force acting on the system (or object) as a function of the geometric arrangement of the surfaces of the object and the applied voltage or voltage differential giving rise to the electric field may be accomplished by computational methods. The εₒE² relation is well known to science. It is the electrostatic pressure on the surface of an object. The permittivity of free space εₒ is 8.85×10⁻¹² F/m and the maximum allowed electric field in air before breakdown is ˜10⁶ V/m. This gives an electrostatic pressure on the order of ˜1 Pa or one Pascal. Since air is approximately 101.3 kPa, electrostatic pressure is about five orders of magnitude less. It is important to note that electrostatic pressure force is not the force or pressure due to Coulomb attraction on a surface. For example, if one surface is positive and the other surface is negative, there will be a strong Coulomb force of attraction between both surfaces which is on the order of

$$\begin{matrix}∼ k {q}_{1} {q}_{2} / {r}^{2} & where & k = \frac{1}{4 π {ε}_{o}} = 9 \times 1 {0}^{9} N {m}^{2} {C}^{- 2}\end{matrix} .$$

Although the electric field is well defined in the region between the two surfaces and consists of a known direction, the direction of the electrostatic pressure force is not dependent upon the direction of the electric field; rather, it is a function of the square of the electric field. Thus, in the example in which the invention comprises a first electrode and a second opposing electrode, the two electrode surfaces will have a strong force of attraction due to the Coulomb coupling constant, but the electrostatic pressure between the two surfaces will push the two surfaces away from each other, albeit a much weaker force than the Coulomb force due to the electrostatic pressure force being linearly dependent on the free space permittivity constant while Coulomb's constant is inversely proportional to that same constant. Thus, in embodiments of the invention that comprise opposing electrodes, the electrodes comprising electrically conductive surfaces of the invention may be attached by a non-electrically conductive structure for in order to prevent them from collapsing together due to the Coulomb force. In embodiments, the structure for securing the electrodes may be non-conductive. In embodiments, the reactive force provided by the structure exactly equals the attractive Coulomb force tending cause the electrodes to come together, allowing the novel net electrostatic pressure force described below, which results from an asymmetry of electrostatic pressure forces acting on the electrodes, to be observed and to be utilized in an net electrostatic pressure force apparatus of the invention.

A novel inventive scheme of the invention makes use of electrostatic pressure force, which, in general, is the product of an electrostatic pressure and the surface area upon which the electrostatic pressure acts. In accordance with the above relationships, depending upon the geometric arrangement of the conductive surfaces (i.e., electrode surfaces) of an object, and the intensity of an applied electric field having a divergence (which may be continuous or non-continuous), the surface or surfaces of an object may be subjected to differing levels of electrostatic pressure resulting from the applied electric field such that, when all electrostatic pressure forces acting on the surfaces of the object are vector summed, a net non-zero resulting electrostatic pressure force acts on the object. When the electrostatic pressure forces on the object are of different vectors such that their sum is a net electrostatic pressure force vector that is non-zero, the electrostatic pressure forces on the object may be described as being “asymmetric”. The value of the electrostatic pressure forces acting on the surfaces of the object may be determined by using computational methods to analyze differing geometric arrangements of the surfaces of the object, some of which may be electrically conductive and subjected to a voltage or voltage difference for generating the applied electric field, and differing levels of voltage or voltage difference applied to the electrically conductive surface or surfaces.

A desired resulting net electrostatic pressure force may be produced by the inventive method steps disclosed and claimed herein, which steps may include defining, in three dimensional space, the size, three-dimensional shape, and arrangement of the electrically conductive surfaces of an object such that, when the object is subjected an electric field (which may be, but is not necessarily, created when a predetermined voltage or voltage difference is applied to electrically conductive surfaces, i.e. electrodes of the object), or when the object is subjected to a divergent electric field, a desired resulting net electrostatic pressure force is produced from the summation of the electrostatic pressure forces resulting from electrostatic pressures acting on the electrically conductive surfaces of the object. The method of defining, in three dimensional space, the size, three-dimensional shape, and geometric arrangement of the electrically conductive surfaces of the object such that a desired resulting net electrostatic pressure force is produced from the vector sum of the electrostatic pressure forces resulting from the electrostatic pressure acting on the surfaces of the object can be done by computational means. Such computational means may, for example, run iterative computations, such as in a Monte Carlo analysis, varying the geometric arrangement of the electrically conductive surfaces and varying the applied voltage or voltage difference, until the desired net resulting electrostatic pressure force is achieved. Using the apparatus and method of the invention, it is possible to achieve a desired net resulting electrostatic pressure force acting on a body or object by determining the geometric arrangement of the conductive surfaces of the body or system such that the net electrostatic pressure force is maximized by maximizing the electrostatic pressure on one or more surfaces of the body or system, and by minimizing the electrostatic pressure on other surfaces of the body or system, such that a resulting net electrostatic pressure force is produced as the electrostatic pressure operates on the various surfaces of the object. Said another way, by creative manipulation of the conductive surfaces on one of the surfaces, or by the presence of a plurality of dielectric materials of differing permittivities in the electric field, there may be created regions of lower electrostatic pressure which may be crafted into a surface that experiences lower electrostatic pressure, therefore having an imbalance of electrostatic pressure acting on it. The surface that has the least electrostatic pressure acting on its surface is subject to less electrostatic pressure force. This may be visualized as one surface making more thrust in a vector direction than the other surface does in the opposite vector direction. In embodiments, the resulting net electrostatic pressure force may be characterized as acting along an axis that is collinear with the net electrostatic pressure force vector. The direction of the net electrostatic pressure force may be determined by computational techniques known in the art for determining the electrostatic pressure resulting from an electric field acting on surfaces of the object.

In embodiments, the asymmetric electrostatic pressure forces acting on the object may be established by the size, geometric three-dimensional shape and three-dimensional arrangement of the electrically conductive surfaces of the object as acted upon by an electric field; or, by the of plurality of dielectric materials of differing permittivities in the electric field to establish a divergent electric field acting upon the electrically conductive surfaces of the object; or a combination of both.

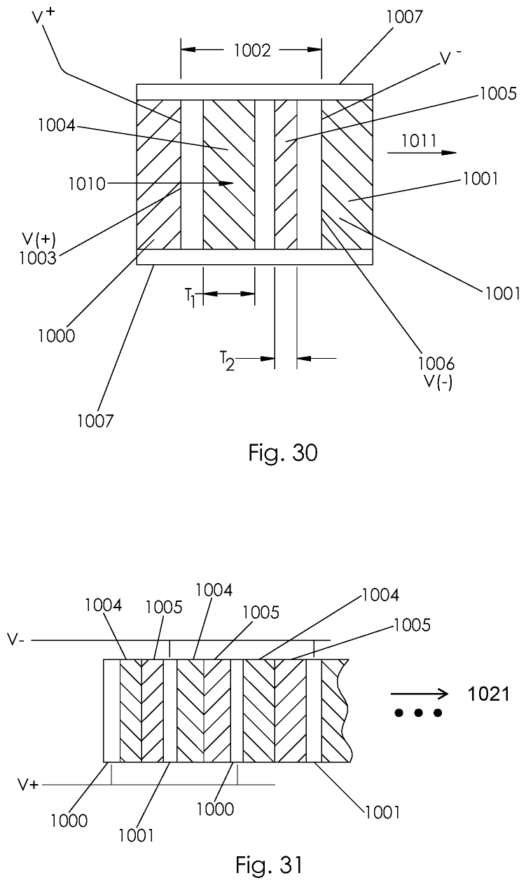

In embodiments, the divergent electric field may be established at least in part, or whole, by the placement of plurality of dielectric materials of differing permittivities in the electric field. The invention may comprise any number of dielectric materials of differing permittivities needed to achieve a desired divergent electric field, resulting in a desired asymmetry of electrostatic pressure forces acting on the electrically conductive surfaces of the object, resulting in a non-zero net electrostatic pressure force acing on the object. Thus, for example as one of but many applications, the invention may act as a thruster that applies a motivating force to an object in a direction of the resulting non-zero net electrostatic pressure force acing on the object. A non-limiting example of such an application is the embodiment of the invention depicted in FIG. 30. Dielectric materials 1010 and 1005, which have differing permittivities ε1 and ε2, respectively, are disposed in an electric field between electrically conductive surfaces (i.e. electrode surfaces) 1003 and 1006. Because dielectric materials 1010 and 1005 have differing permittivities, the electric field between electrically conductive surfaces (i.e. electrode surfaces) 1003 and 1006 is a divergent field, resulting in greater electrostatic pressure on surface 1006 than the electrostatic pressure on surface 1003, thus creating an asymmetry in the electrostatic pressure force acting on electrically conductive surface 1003 and the electrostatic pressure force acting on electrically conductive surface 1006, resulting in a non-zero net electrostatic pressure force 1011. The electric field may be, but is not necessarily, established by the application of differing voltages V+ and V− to electrodes surfaces 1003 and 1006, respectively.

In embodiments, the electric field acting upon electrode conductive surfaces and/or dielectric material disposed in the electric field may be created in part or in whole by the application of differing voltages to one or more electrodes of the apparatus. In embodiments, the electric field acting upon electrode conductive surfaces and/or dielectric material disposed in the electric field may be created in part or in whole by external sources such as an naturally occurring or man-made electric field; in such embodiments, it may not be necessary for any voltage to be applied to the electrodes of the invention because the electric field may be established by such external sources. In embodiments, the electric field acting upon electrode conductive surfaces and/or dielectric material disposed in the electric field may be established in part or in whole by the application of differing voltages to one or more electrodes of the apparatus, and in part by external sources such as any naturally occurring or man-made electric field.

### Differentiation from Other Theories of Operation

The present invention does not require the use of an ion wind to generate the force. Interestingly, if ion wind is generated using geometries described herein, the electrostatic pressure force is in the same direction of the wind. [Imagine a rocket moving in the direction of its exhaust]. In embodiments, the invention may be encapsulated in an enclosure to remove ion wind effects. The proof of concept and reduction to practice tests mentioned herein were generally performed within an enclosed box to nullify ion wind effects.

Force measurements are performed on the box itself which removes all doubt that the forces observed are contained within the box and not due to outside effects such as ion wind and Coulomb attraction to exterior surfaces (walls, chambers, etc.). The Coulombic attraction to other surfaces is prevented by sufficiently grounding the test chamber box.

Many of the measurements performed on the test devices described herein make use of direct current (DC), or non-time-varying applied voltages, which eliminates magnetic effects. Magnetic effects are well known to occur if a system uses strong currents which can interact with the Earth's magnetic field via Lorentz Law forces, resulting in unwanted forces and torques on that system. Magnetic fields can also be generated by constant currents (Ampere's Law) or changing electric fields (Faraday's Law) which can interact with the Earth's magnetic field as well. The present invention has proven to work in DC, i.e. non-time-varying voltage, mode which eradicates all magnetic components for explaining the phenomenon.

Without the presence of a magnetic field, the present invention does not generate field momentum. Classical electrodynamic fields possess momentum, as was first realized by Poynting [1884] and discovered independently by Heaviside [1885], who found that a finite cross-product of E×B is proportional to a momentum density. The fact that this momentum occurs for every frequency including zero frequency, as in the case of static fields, has troubled scientists since the beginning of the formulation of electrodynamics and has only recently been widely accepted and appreciated. The notion that fields carry momentum similar to the way in which particles do has led scientists to resolve paradoxes that question whether electrodynamics obeys Newton's laws. One famous example involves two charged particles moving at right angles towards one another. The electrical force between them is repulsive but the magnetic force is not equal and opposite [Page and Adams, 1945]. This seems to violate Newton's third law. Only when the field momentum of the charges is taken into account does the conservation-of-momentum laws hold.

It is possible to use angular field momentum to impart mechanical momentum onto a system. The famous Feynman disk paradox shows how stored angular field momentum can be converted into mechanical rotational momentum [Feynman 1965]. This has been verified experimentally by Graham and Lahoz [1980]. As a result of the insight provided by Dr. Feynman many researchers have proposed the use of linear field momentum as a tool for propellentless propulsion. The idea first arose more than 50 years ago when Dr. Joseph Slepian theorized that a craft can be propelled by “a means of propulsion which does not require any material medium upon which the propelling thrust is exerted” [Slepian 1949]. Work continues into the 21^{st} century to investigate the possibility that field momentum (E×B) could provide forces on objects without expelling propellants [Corum, et al. 2001]. The Electromagnetic Momentum Generator (EMMG) developed by Brito [Brito 1999, 2001 and 2003] is a toroid geometry used to generate field momentum in the x-direction that supposedly generates a very small mechanical force in that direction. It uses a parallel-plate ring configuration to generate the electric field in the radial direction encompassed by a current-carrying coil to create the circumferential magnetic field. Their belief was that having the field momentum present itself was enough to generate a force.

However, the consensus of NASA's Breakthrough Propulsion Project (BPP) in 2003 was to independently verify any net thrust claim in the area of field momentum, a task given to the Astronautics department at the United States Air Force Academy. Experiments by Bulmer and Lawrence [2003] aimed to monitor any change in the momentum of a laser beam as it passed through a volume containing linear field momentum. A laser beam was placed within this volume parallel to the electrodes whose DC offset was monitored. The belief was that any change in the DC offset would suggest an acceleration of space where the field momentum existed. However none was ever detected.

Although there are many researchers trying to use field momentum as a means to produce a linear force as an analog to the Feynman disk, none have been successful. This is most likely as a result of not addressing the hidden momentum.

The invention is not subject to the recently discovered “hidden momentum”, a momentum commonly used to cancel field momentum. This additional momentum, which is a relativistic effect, derives from internal stresses of the system, was not formally introduced until 1967 by Shockley and James [1967]. They considered a system of two counter-rotating oppositely charged flat disks in the presence of the field of a charged particle. As the disks slow, the changing electric field creates a magnetic field that acts on both the particle and the disks. This appears to give the system a total net force, thus requiring an internal equal and opposite force if the system is to remain stationary. This paradox was resolved a year later by Coleman and Van Vleck [1968], who used the Darwin Lagrangian to solve for the equations of motion (a more complete discussion was provided by Furry [1969]). They found that the electric field of the charged test particle does exhibit a force on the magnet due to relativistic effects. This can be explained using a simple model developed by Haus and Penfield [1968].

The hidden momentum is a relativistic effect that only applies to moving charge carriers. For example, it is the hidden momentum that balances any static field momentum in the case of either current loops or magnetic dipoles (which are represented as small current loops) in the presence of external electric fields. It does not apply to divergent currents. The concept of hidden momentum has helped scientists recover momentum conservation for several cases, including the explanation of the Aharonov-Bohm effect [Aharonov et al., 1987] for the behavior of neutrons in the presence of static fields and magnetic dipoles in the presence of electric fields [see Griffiths 1992; Hnizdo 1991; Lawson 1982].

In short, the invention does not operate on a theory of ion wind, Coulomb attraction to walls, interactions with the Earth's magnetic field, field momentum or hidden momentum. The technology of the present invention is not the result of the changing mass such as the Mach Effect nor is it related to some effects related to the quantum vacuum fluctuations as theorized by the makers of the EM Drive.

### Exemplary, Non-Limiting Embodiments of the Invention

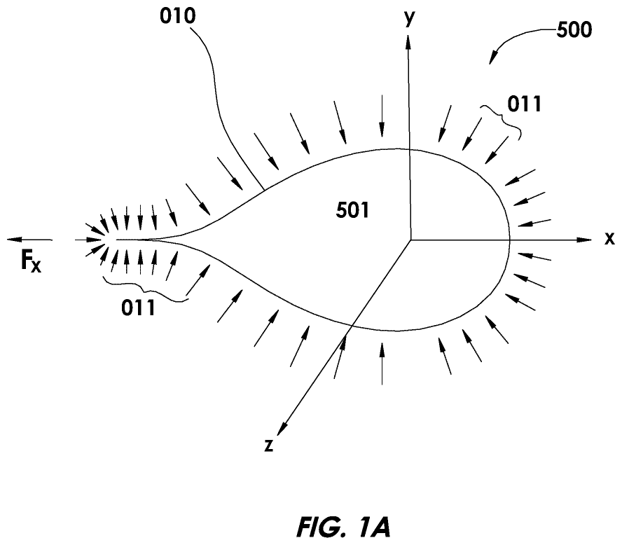

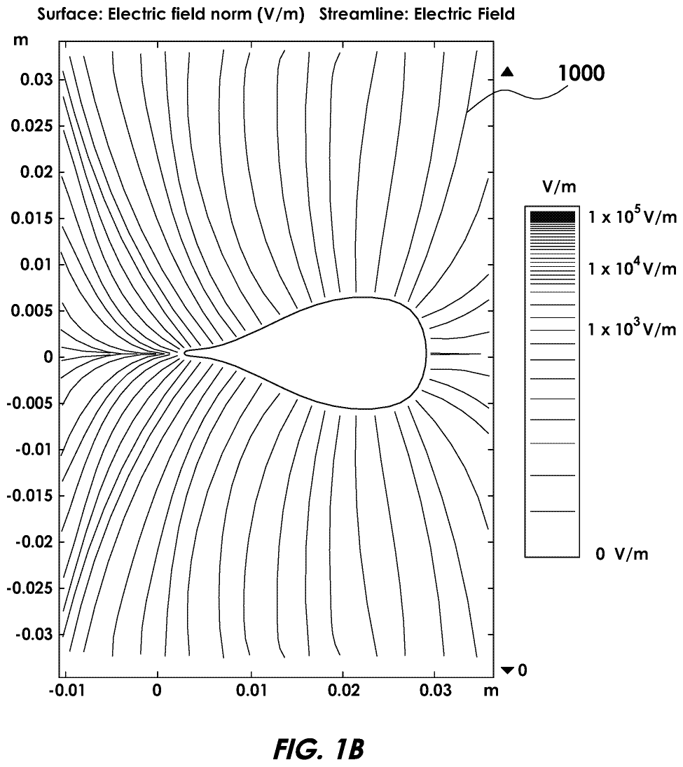

Referring now to FIGS. 1A and 1B, a non-limiting, exemplary embodiment of the invention comprising a single electrode is depicted. An object 500, which comprises an electrically conductive surface or plurality of surfaces 501 is provided with an electric charge such that electrically conductive surface or plurality of surfaces 501 is maintained at that voltage. The application of the voltage to the electrically conductive surface or plurality of surfaces 501 cause an electric field to be formed around body 500 as shown in FIG. 1B, creating electrostatic pressure on the surface or plurality of surfaces 501, resulting in electrostatic pressure 011 on surface or plurality of surfaces 501. When the three dimensional shape of object 500 is determined, by the use of computational techniques, to be of non-uniform cross section in any direction (in the exemplary embodiment shown, along the x axis), the summation of the electrostatic pressure forces acting on surface or plurality of surfaces 501 in such direction will be non-zero, i.e. will result in net resulting electrostatic pressure force Fₓ acting on object 500. If the net resulting electrostatic pressure force Fₓ is not opposed by any other force, body 500 will be accelerated in the direction of net resulting electrostatic pressure force Fₓ. In the embodiment depicted in FIGS. 1A and 1B, the electrically conductive surface or plurality of surfaces 501 form the single electrode of the invention. If object 500 is in contact with or forms a part of another structure along the axis of the net resulting electrostatic pressure force Fₓ, object 500 will act on that structure with force Fₓ. The electric field is depicted by field electric lines 1000.

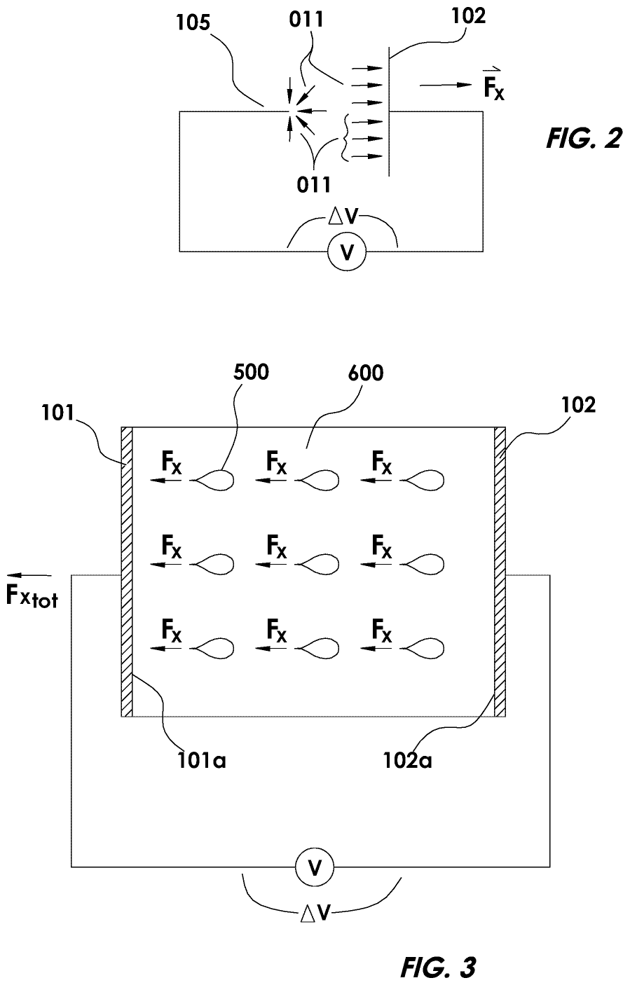

Referring now FIG. 2, a non-limiting, exemplary embodiment of the invention comprising two electrodes is depicted. In this embodiment, an object may comprise first electrode 101 is an electrically conductive wire, and second electrode 102 is shown as a plate comprising electrically conductive surfaces, but may take any shape determined by computational techniques as described herein to define a geometric arrangement of first electrode 101 and second electrode 102, and to define an applied voltage difference ΔV, to produce a desired net resulting electrostatic pressure force Fₓ. Voltage difference ΔV may be applied between first electrode 105 and second electrode 102 by, for example, a wire, creating an electric field that in turn results in electrostatic pressure forces 011 acting on first electrode 105 and second electrode 102. First electrode 105 and second electrode 102 may be attached by non-electrically conductive means 103 that does not provide electrical conductivity between first electrode 105 and second electrode 102. A net resulting electrostatic pressure force Fₓ, which is the vector sum of all electrostatic pressure forces acting on the object, will act on the structure consisting of structure 103, first electrode 105 and second electrode 102.

Referring now to FIG. 3, a non-limiting, exemplary embodiment of the invention comprising a plurality of electrodes suspended between a pair of electrodes is depicted. In this embodiment, a plurality of electrodes, such as, for example, electrode 500 depicted in FIG. 1, may be dispersed, or suspended, between a first electrode 101 and a second electrode 102. A voltage difference ΔV may be applied across first electrode 101 and second electrode 102, creating an electric field between them that causes electric polarization of electrodes 500, resulting in electrostatic pressure forces Fₓ acting on each of electrodes 500 such that each electrode 500 is acted on by a net resulting electrostatic pressure force Fₓ as described herein relative to FIG. 1. The vector sum of these net resulting electrostatic pressure forces Fₓ acting on each electrode 500 results in a total net resulting electrostatic pressure force Fₓtot acting on object 001. In such embodiments, it is not necessary that each of electrodes 500 be similar in shape or size. Using the computational techniques as described herein, a user may utilize any shapes for electrodes 500 that will result in net resulting electrostatic pressure forces Fₓ as may be desired, for example, to achieve a desired Fₓtot. In this example electrodes 500 may be fixedly attached to first electrode 101 and second electrode 102 via one or more non-conductive physical structures, or may be encapsulated or otherwise fixedly disposed in a medium 600, such the forces Fₓ on each of the electrodes 500 is translated to object 001. Medium 600 may be, but is not necessarily, a non-conductive solid material.

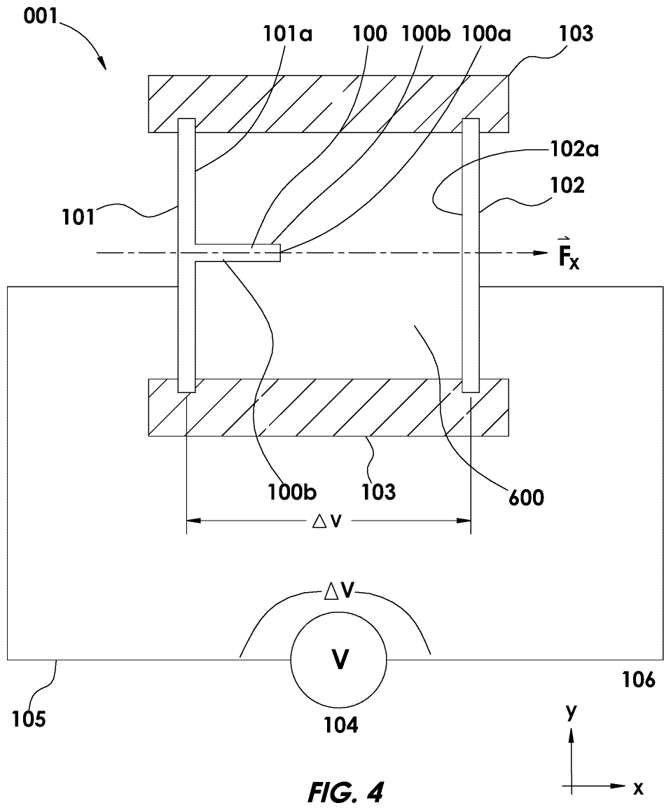

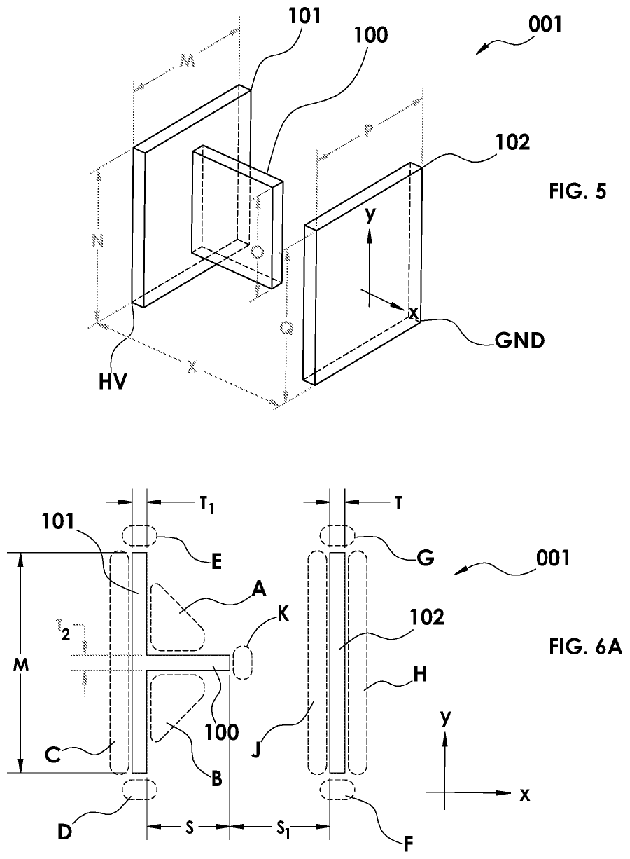

Referring now to FIGS. 4-8, a non-limiting, exemplary, single-stage embodiment of an electrostatic pressure force apparatus of the invention is depicted. The embodiment depicted in FIGS. 4-8 is one of many embodiments that comprise the inventive schemes of the invention, and thus the single-stage embodiment of the invention depicted in FIGS. 4-8 is merely one physical embodiment of many physical embodiments of the invention. In the exemplary embodiment of the electrostatic pressure force apparatus depicted in FIG. 4, the invention may comprise at least one set of opposing first and second electrodes 101 and 102, respectively. First electrode 101 may have electrically conductive surfaces 101a and 100a that each oppose an electrically conductive surface 102a of a second electrode 102. Electrodes 101 and 102, and their opposing electrically conductive surfaces 101a, 100a and 102a, may comprise materials such that the electrodes and their surfaces are continuously conductive throughout, such as, for example, may be the case in which electrodes 101 and 102 are each fabricated from a homogenous piece of electrically conductive material; or, either or both of first electrode 101 and second electrode 102 and their opposing surfaces 101a, 100a and 102a may be discontinuously electrically conductive, such as, for example, in an embodiment in which either one, or both, of first electrode 101 and second electrode 102 are fabricated from a plurality of materials, some of which may be electrically non-conductive. Electrode 101 may comprise at least one proximal surface 100a which may be electrically conductive and at least one distal surface 101a which may be electrically conductive, each of surface 101a and 101a opposing electrically conductive surface 102a of electrode 102, wherein proximal surface 100a may be disposed in closer proximity to second electrode surface 102a than distal surface 101a. At least one proximal surface 100a may be connected to, and in electrical communication with, at least one distal surface 101a by electrically conductive surface 100b. Electrodes 101 and 102, and thus their opposing surfaces 101a and 102a, and 100a and 102a, may be attached in any manner, such as fixedly attached, by any non-electrically conductive means, represented in FIG. 4 by element 103 which is merely an exemplary shape of a non-electrically conductive means for fixedly attaching electrode opposing surfaces 101a, 100a and 102a. The exemplary structure comprising electrode 101, and electrode 102, and non-electrically conductive attaching means 103 as depicted in FIGS. 4-8 may be herein referred to as a single-stage embodiment of the invention. It is understood that the physical embodiment shown in the figures of this single stage embodiment is not limiting but is rather exemplary, and that any physical configuration of devices or structures that comprise the essential elements of the invention are within the scope and breadth of the claimed invention.

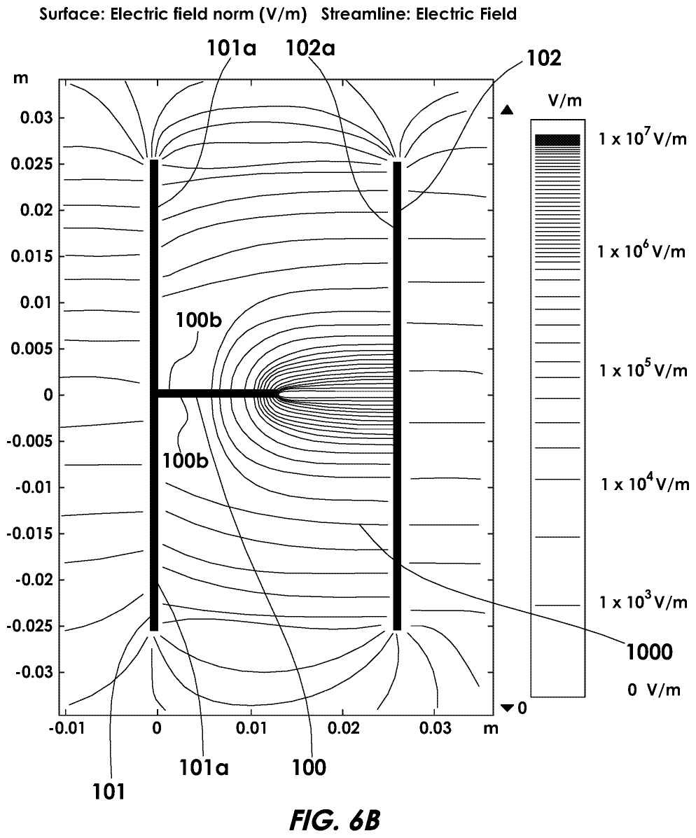

Still referring to FIGS. 4-8, an applied voltage difference ΔV between first shaped electrode surfaces 101a and 100a and said second shaped electrode surface 102a, causes an electric field, which may be non-uniform or non-homogeneous, to be generated between first shaped electrode surfaces 101a and 100a and second shaped electrode surface 102a (see FIG. 6). The electric field, which is depicted by the field lines of FIG. 6B, has regions of differing magnitude as depicted in order of ascending intensity by regions A and B, C, H, J and D/E/F/G in FIG. 3. The local intensity, direction and shape of the electric field is a function of the intensity, polarity and time-varying characteristics (if any) of the applied voltage difference ΔV between first electrode surfaces 101a, 100a and second electrode surface 102a, and, for the exemplary embodiment shown in FIGS. 4-8, the geometric arrangement of shaped electrode surfaces 101a, 100a and 100b and said second shaped electrode surface 102a and the geometry of the separation between shaped electrode surfaces 101a and 100a and said second electrode surface 102a as given by T, T1, T2, M, N, O, P, Q, S, Si, U, and V (see FIGS. 2 and 3).

It is a feature of the claimed invention, in any embodiment, that the geometric arrangement of the surfaces off the object, and the applied voltage or voltage difference, may be determined by a user using, for example, the computational methods of the invention, in order to achieve a desired resulting net electrostatic pressure force Fₓ as described herein, and that, as such, the scope of the invention is not limited by the depictions of the figures or the use cases described herein, which are all merely exemplary in nature.

Still referring to FIGS. 4-8, and specifically referring to FIG. 8, the non-homogeneous electric field results in electrostatic pressure forces as depicted by the arrows shown, in accordance with the theory presented herein, resulting an electrostatic pressure tending to separate electrode surfaces 101a and 102a and 100a and 102a, and, as a result, tending to separate electrodes 101 and 102. It is a feature of the invention, in all embodiments, that the shape and geometry of electrode surfaces 101a, 100a and 102a, and the separation between them, may be determined by a user such that the electrostatic pressures caused by the electric field arising from the applied voltage difference ΔV between first electrode surfaces 101a and 100a and second electrode surface 102a results in a net imbalance of electrostatic pressure forces (see FIG. 4) acting in the x direction, as shown in the figures, between the first electrode surfaces 101a and 100a and the second electrode surface 102a. Because this net imbalance of electrostatic pressure forces exists in the x direction, and because electrodes 101 and 102 are attached, which may be a fixed attachment, through structure or forces 103, a resulting net electrostatic pressure force Fₓ having a vector is applied to attached elements 101, 102 and 103. If attached elements 101, 102 and 103 are disposed in an environment such that the sum of the magnitude of any environmental forces opposing the resulting net electrostatic pressure force Fₓ is less than the magnitude of resulting net electrostatic pressure force Fₓ, translation of attached elements 101, 102 and 103 in the direction of the vector of resulting net electrostatic pressure force Fₓ will occur. The acceleration of fixedly attached elements 101, 102 and 103, and any structure to which they are attached, is given by the momentum relation F=ma, where “F” is the vector sum of Fₓ and all opposing forces, “m” is the total mass of the elements 101, 102 and 103, and any structure to which they are attached, and “a” is the acceleration of elements 101, 102 and 103, and any structure to which they are attached. With regard to the y direction, for the embodiment show, the forces on the structure created by 101, 102, and 103 in the y direction may, but do not necessarily, cancel out, resulting in no net force with a y direction component. However, it may be desirable that forces in the y direction not cancel, and, in such cases, electrodes 101 and 102 may be shaped as described herein in order to provide a non-net-zero force in the y direction.

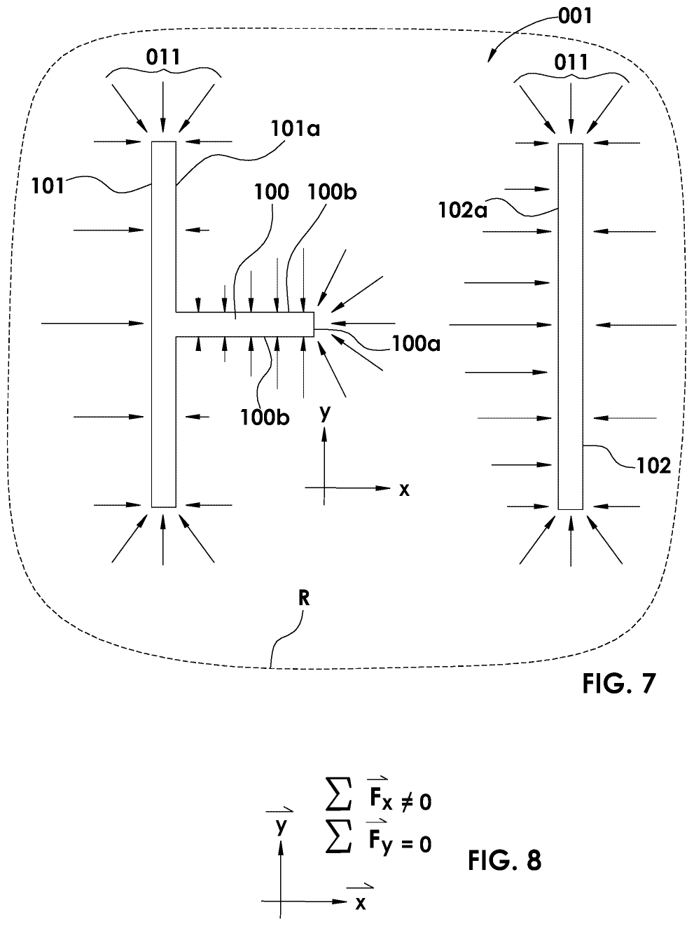

In any embodiment of the invention, a voltage V+ or V− may be established on electrode surface 102a and a voltage V+ or V− may be established on electrode surfaces 101a and 100a such that there is a voltage difference applied ΔV between electrode surfaces 101a and electrode surface 102a, and there is a voltage difference ΔV applied between electrode surfaces 100a and electrode surface 102a. Electrode surfaces 100a and 101a may be at the same voltage. A specific separation distance X is established between electrode 101 and electrode 102, and an electric field gradient is created. By this physical geometry and the application of electrical potential difference ΔV to the electrode surfaces, regions of high electrostatic field intensity D, E, F and G and low electrostatic field intensity A and B are created in conformance with the afore described electrostatic theory. Examples of these regions may be, in ascending order of intensity, A and B, C, H, J and D/E/F/G as shown in FIG. 6. Electrostatic pressure over an area is computed as the product of each region of electrostatic field intensity multiplied by the area over which it occurs. When ΔV applied across the electrode surfaces as herein described, electrostatic pressure vectors as depicted in FIG. 7 result. These electrostatic pressure vectors may be summed along all three axes as defined in FIG. 8. It is an inventive scheme of the present invention that the physical shapes of the various conductive elements, i.e. electrode surfaces, and the physical and geometric relationships between the electrode surfaces can be adapted to optimize the regions of higher electrostatic pressure and lower electrostatic pressure being asserted on the electrode surfaces, thereby optimizing the summation of forces acting on any embodiment of the invention. It is this optimization of shape and form of the core electrode surfaces, the application of electrical potential difference ΔV to the electrode surfaces and the resulting non-homogeneous electric field, yielding predicted vector summations of electrostatic pressures acting over predictable surface areas to achieve a desired resulting net force F, which resulting net force F is not a result of ion wind, Coulomb attraction to walls, interactions with the Earth's magnetic field, field momentum or hidden momentum; that is a novel aspect and inventive scheme of the present invention.

As an example of but one of numerous use cases of the invention, if elements 101, 102 and 103 are attached to a spacecraft structure in a vacuum or near vacuum environment, acceleration of the spacecraft will occur when ΔV is applied to electrodes 101 and 102 as herein described. If the resulting net electrostatic pressure force Fₓ is applied on a vector passing through the center of mass of the spacecraft, translation of the spacecraft without rotation will occur. If the resulting net electrostatic pressure force Fₓ is applied on a vector that does not pass through the center at the center of mass of the spacecraft, both rotation and translation of the spacecraft will occur. Thus the electrostatic pressure force apparatus of the invention, when used as means for motivating an object, may be described as an electrostatic pressure force thruster.

Still referring to FIGS. 4-8, the applied voltage difference ΔV may be applied by any electrical source 104 which may produce a non-time-varying or time-varying voltage difference ΔV. Thus the voltage difference ΔV applied to electrodes 101 and 102 may be, or may not be, time-varying. The polarity of applied voltage difference ΔV may be any polarity; i.e. the resulting vector of resulting net electrostatic pressure force Fₓ is not affected by the polarity of applied voltage difference ΔV, because the net electrostatic pressure force Fₓ is a function of the square of the electric field and is thus independent of the polarity of the applied voltage difference ΔV. The direction of the net electrostatic pressure force Fₓ is a function of the shape of first electrode surfaces 101a and 100a and the second electrode surface 102a as described herein. The electric field is depicted in FIG. 6B by field electric lines 1000.

Still referring to FIGS. 4-8, an optional dielectric material 600 may be disposed between electrodes 101 and 102 in order to prevent breakdown at higher applied voltage differences. The use of optional dielectric material 600 may be beneficial for specific use cases. Dielectric material 600 may be any dielectric material. In general, any embodiment of the invention comprising more than one electrically conductive surface, or which employs a voltage difference to develop the electric field, may, but do not necessarily, comprise optional dielectric material 600 disposed between any of electrically conductive surfaces of the invention.

In any embodiment of the invention, the lower voltage V− of the applied voltage difference ΔV may be, but is not necessarily, a system, chassis or other ground.

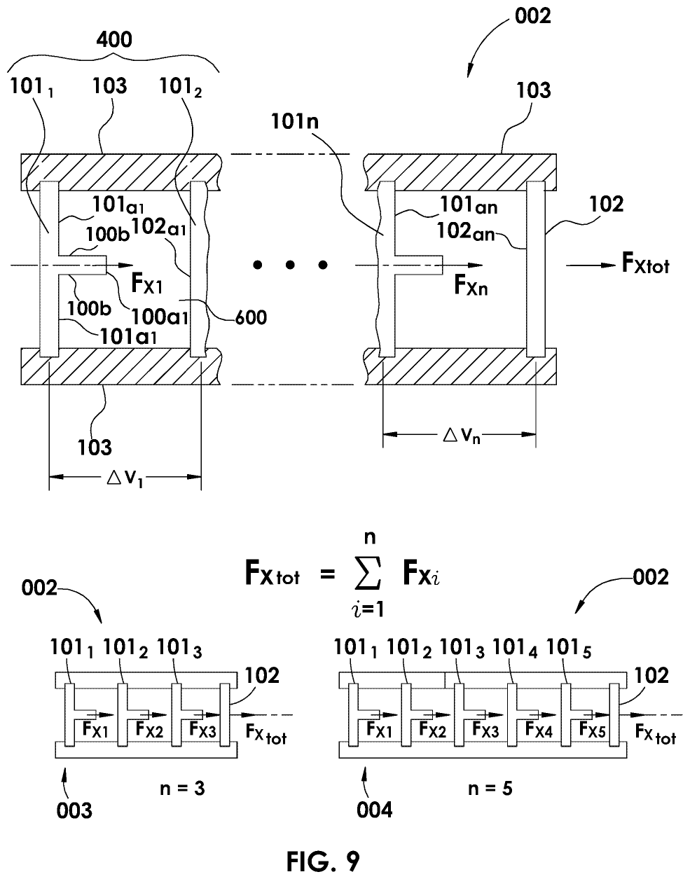

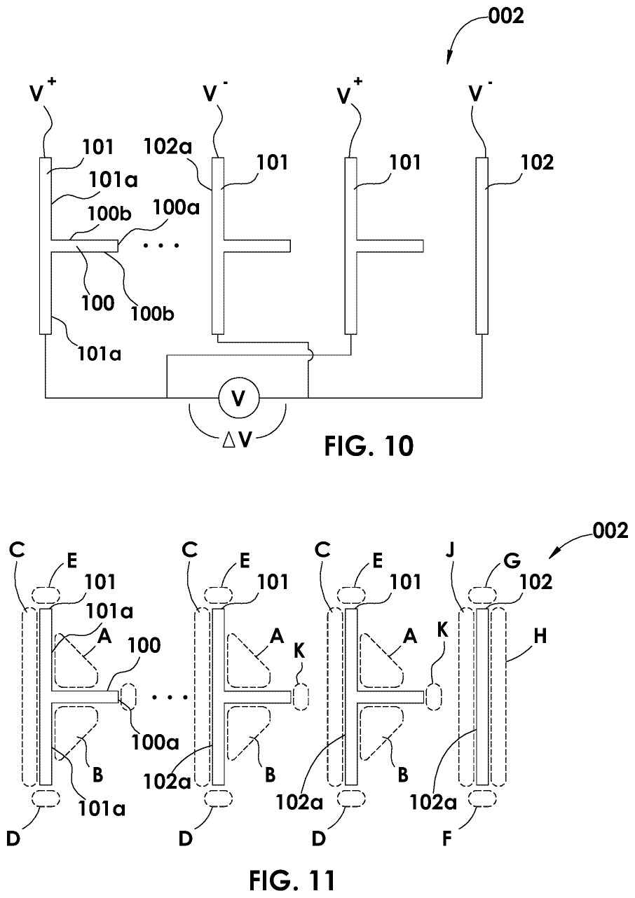

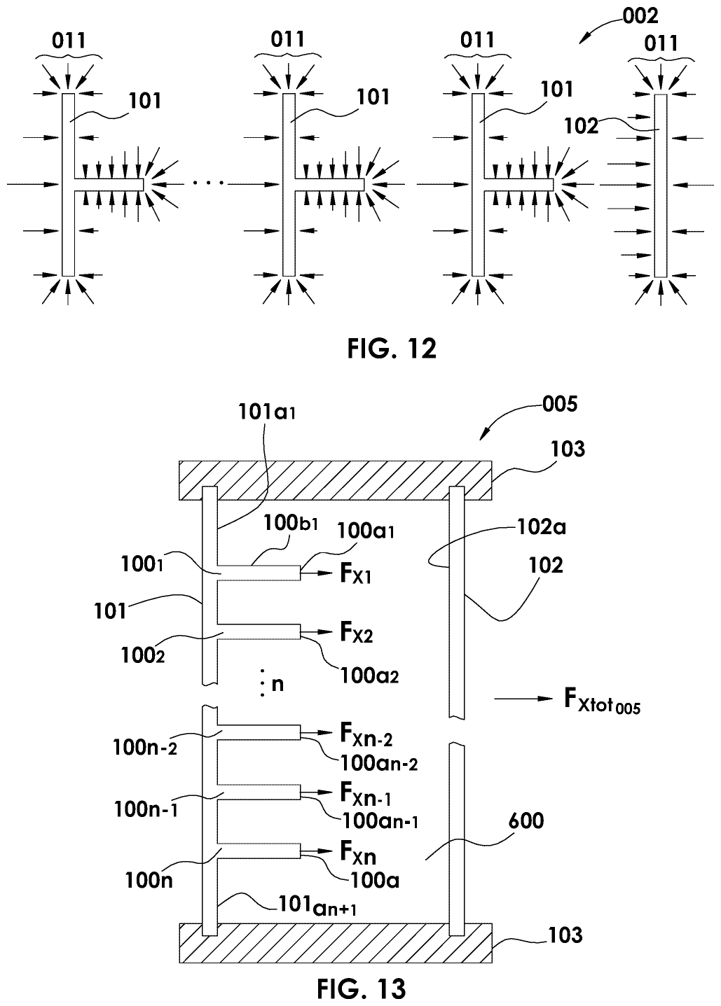

Referring now to FIGS. 9-12, an embodiment of an electrostatic pressure force apparatus of the invention 002 is depicted in which the invention comprises an object having multiple stages, each stage comprising a set of opposing electrodes 101ₙ and 102ₙ attached, and, in embodiments, fixedly attached, by non-electrically conductive means 103 as previously described in regard to FIGS. 4-8. A plurality of n sets of electrode surfaces 400, each set of electrode surfaces 400 comprising 101aₙ, 100aₙ and 102aₙ, may comprise a multi-stage embodiment of the invention comprising n sets of electrode surfaces 400. For each set of electrically conductive electrode surfaces, an applied voltage difference ΔVₙ between first electrode electrically conductive surfaces 101aₙ and 100aₙ and second electrode electrically conductive surface 102aₙ causes a non-homogeneous electric field to be generated between electrically conductive electrode surfaces 101ₙ and 100ₙ and second electrically conductive electrode surface 102ₙ as described in regards to FIGS. 4-8 hereinabove, resulting in a net electrostatic pressure force Fₓₙ for each set 400 of opposing electrode surfaces 101ₙ, 100ₙ and 102ₙ which vector sum together to result in a total net electrostatic pressure force Fₓtot acting on the object. Referring specifically to FIG. 6, a three-stage electrostatic pressure force apparatus 003 is depicted as an exemplary embodiment of a multi-stage electrostatic pressure force apparatus of the invention 002 in which n=3, and a five-stage electrostatic pressure force apparatus 004 is depicted as a further exemplary embodiment of a multi-state electrostatic pressure force apparatus of the invention in which n=5. Because the direction of the net resulting state electrostatic pressure force on each stage is independent of the polarity of the applied voltage difference ΔVₙ between electrode electrically conductive surfaces 101aₙ and 100aₙ and electrode electrically conductive surface 102aₙ for that stage, the applied voltage to each successive electrode electrically conductive surface may be either V+ and V− as long as an applied voltage difference ΔVₙ is present between electrode surfaces 101ₙ, 100ₙ and 102ₙ for each electrode surface set 400.

Still referring to FIGS. 9-12, it is not necessary that n be an odd number. I.e., it is not necessary that there be an odd number of electrode sets in a multi-stage embodiment of an electrostatic pressure force apparatus of the invention. It also is not necessary that each 101aₙ electrode electrically conductive surface be similarly shaped, that each 100aₙ electrode surface be similarly shaped, or that each 102aₙ electrode surface be similarly shaped. Said another way, each electrode and electrode electrically conductive surface comprising a multi-stage electrostatic pressure force apparatus of the invention 002 may be shaped as determined by the computational methods described herein to achieve any desired electric field and any desired resulting net electrostatic pressure force F×ₙ on any particular stage, that thus to determine the total resulting net electrostatic pressure force Fₓtot acting on the object, which is the vector sum of all resulting net electrostatic pressure force F×ₙ acting on each stage.

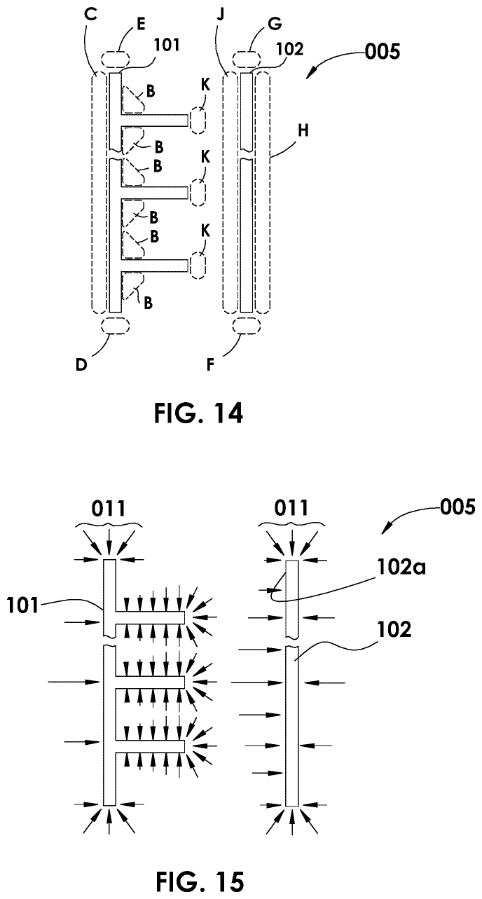

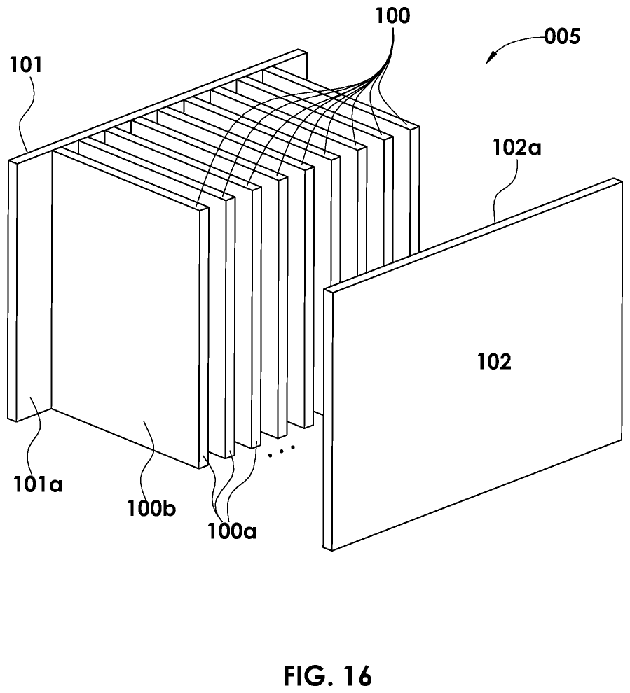

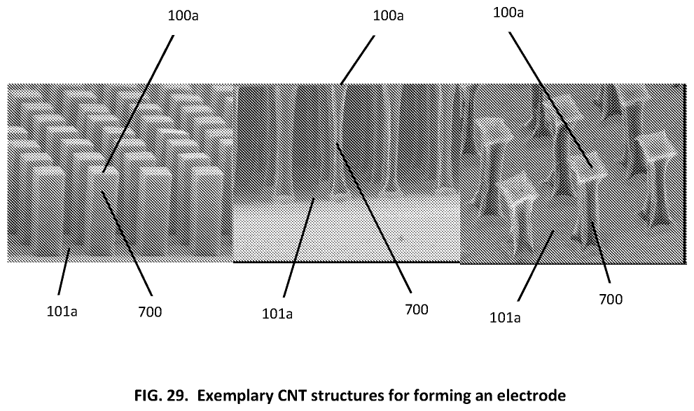

Referring now to FIG. 13-16, an exemplary embodiment of the electrostatic pressure force apparatus of the invention 005 is depicted in which electrode 101 comprises a plurality of electrode electrically conductive surfaces 101aₙ₊₁ and a plurality of electrode electrically conductive surfaces 100aₙ that oppose electrode electrically conductive surface 102a of electrode 102, establishing a non-homogeneous electric field between the plurality of electrode electrically conductive surfaces 101aₙ₊₁ and the plurality of electrode electrically conductive surfaces 100aₙ and electrode electrically conductive surface 102a that results in a resulting net electrostatic pressure force Fₓtot as described herein. This embodiment comprises a plurality of n “blades” 100, labeled 100₁ through 100ₙ. The shape of blades 100 may take any shape desired by a user, as determined by the computational techniques described herein, in order to achieve a desired electrostatic pressure forces F₁-Fₙ, and a resulting net total electrostatic pressure force Fₓtot acting on said object. The shape of blades 100 is depicted as examples only in the figures. In embodiments, blades 100 may take any geometric shape and may extend between one electrically conductive surface of the invention to another electrically conductive surface, and may be at least partially electrically conductive such the two surfaces it extends between are electrically conductively connected. Thus, elements 700 of FIG. 29 may be considered blades.

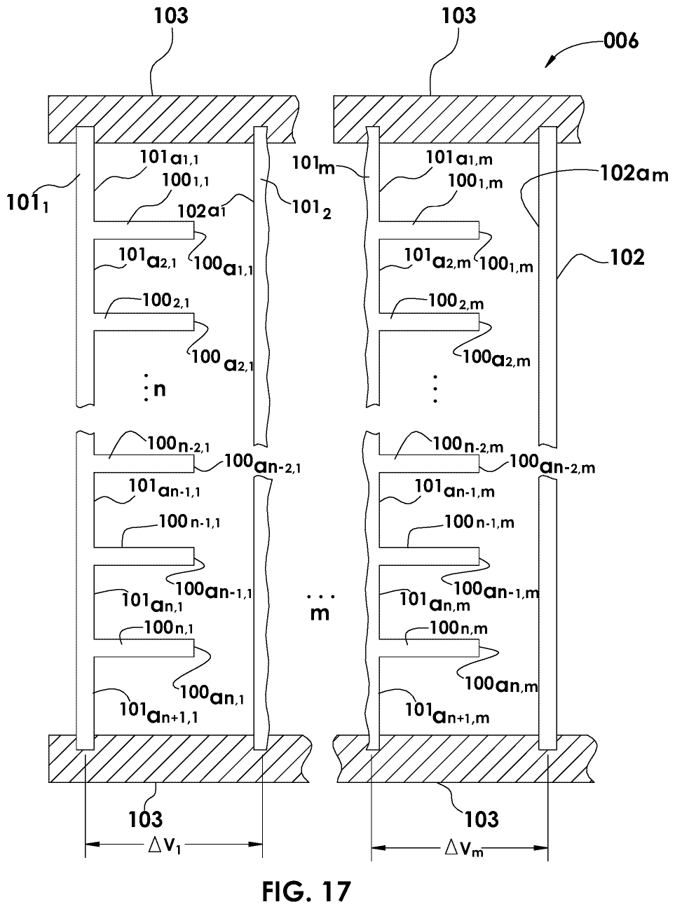

Referring now to FIG. 17, a further exemplary multi-stage embodiment of the electrostatic pressure force apparatus of the invention 006 is depicted in which the invention comprises an object having m stages identified successively as stage 1 through stage m. In each stage, an electrode 101 comprises a plurality of electrode surfaces 101a₁ through 101aₙ₊₁ and a plurality of electrode surfaces 100a₁ through 100aₙ that oppose electrode surfaces 102a, establishing a non-homogeneous electric field between the plurality of electrode electrically conductive surfaces 101aₙ₊₁ and the plurality of electrode electrically conductive surfaces 100aₙ and electrode electrically conductive surface 102a that results in a resulting net electrostatic pressure force Fx005 as described herein. This embodiment comprises a plurality of n “blades” 100 per electrode 101, labeled 100₁ through 100ₙ. Each blade may comprise an electrically conductive electrode surface 100a as depicted in the figure, using the inventive schemes herein described. The shape of blades 100 may take any shape desired by a user in order to achieve a desired electrostatic pressure forces F₁-Fₙ and a resulting net total electrostatic pressure force Fₓtot acting on the object. Each electrode 101₁₋ₘ and 102 may be attached, and, in an embodiment, fixedly attached, by non-electrically conductive means 103.

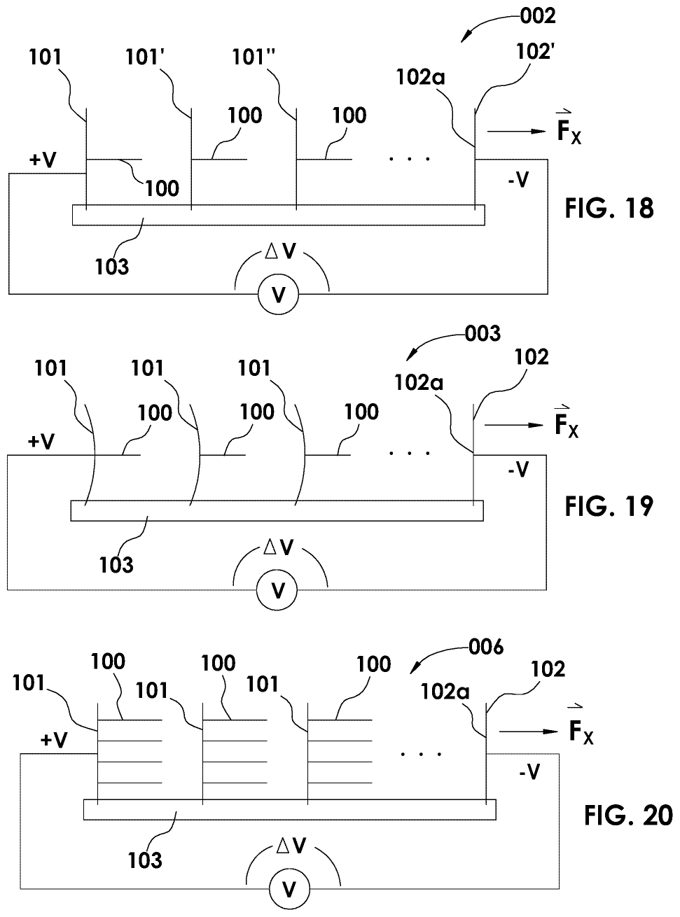

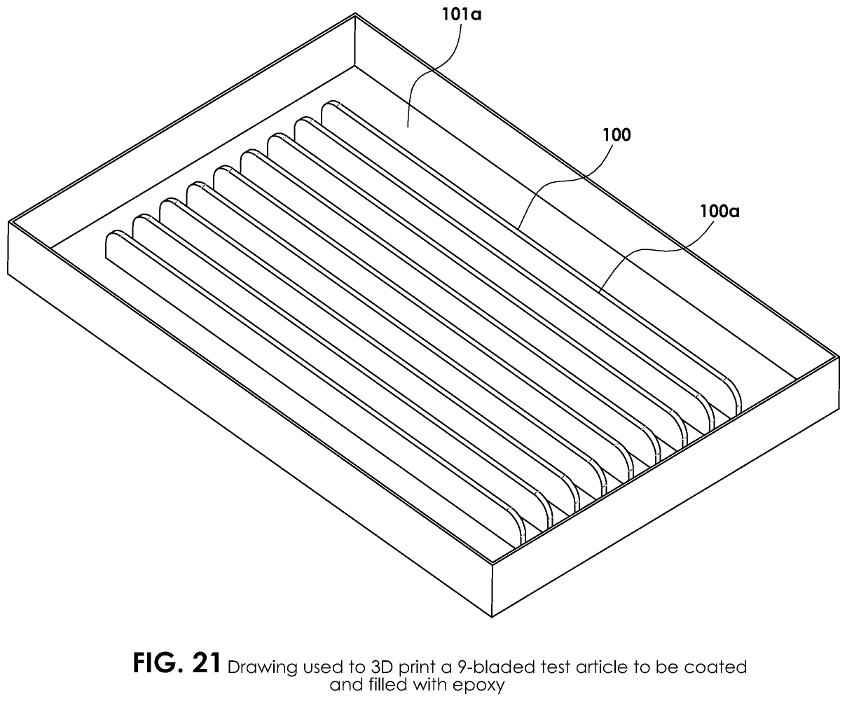

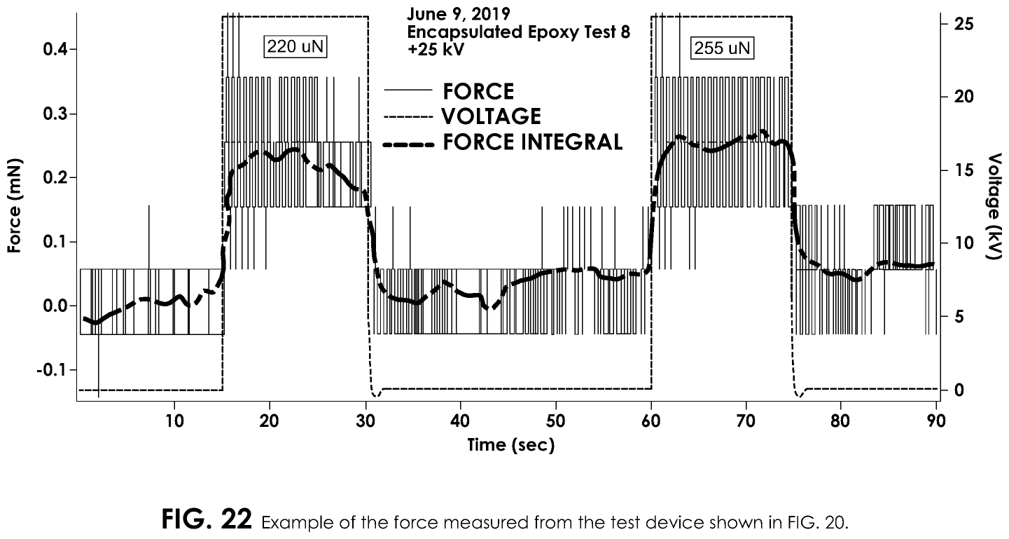

Referring now to FIGS. 18-20, embodiments of the invention are depicted in which each embodiment comprises a plurality of electrodes, each of which may be aligned along an axis, in which an outermost pair of electrodes 101′ and 102′ are subjected to an voltage difference ΔV, which may be supplied by a voltage source V. One or more electrodes 101″ may be disposed between electrode 101′ and electrode 102′. The voltage difference ΔV between electrode 101′ and electrode 102′ creates an electric field between them that causes electric polarization of electrodes 101″. The electric field results in electrostatic pressure as herein before described acting on the conductive surfaces of one or more of the electrodes which in turn results in electrostatic pressure forces acting on the conductive surfaces of one or more of the electrodes as described herein, creating a net resulting electrostatic pressure force Fx acting on each of the electrodes as described herein. The electrodes in each embodiment may be attached by non-electrically conductive means. Each of the net resulting electrostatic pressure forces Fₓ may be summed together, resulting in a total net resulting electrostatic pressure force Fₓtot as depicted. The specific shape of each of the electrodes may be determined by computational methods as described herein to achieve a desired net resulting electrostatic pressure force Fₓ on each electrode, or to achieve a desired total net resulting electrostatic pressure force Fₓtot. These examples are provided to emphasize that the computational method of the invention described herein may result in any number of geometric arrangements of electrically conducting surfaces that, when subjected to a voltage or voltage difference, may give rise to an electric field that produces electrostatic pressure on the surfaces of the object, in turn resulting in electrostatic pressure forces acting on the surfaces of the object in such a manner that a net resulting electrostatic pressure force acts on the object. In embodiments, the net resulting electrostatic pressure force is non-zero.

### Multi-Blade Test Cases

An example of a test article of an embodiment of the electrostatic pressure force apparatus of the invention used to verify functionality of the invention as herein described is shown in FIG. 21. An embodiment comprising nine blades 100 arranged as depicted, each blade being substantially 0.25 inches in height, spaced 0.25 inches apart with each blade being substantially four inches in length, was fabricated. The gap between surfaces 100aₙ and 102a (see FIG. 13) was 0.25 inches. The 0.05 inch thick blades 100 and the back plane electrode 101 were coated with a conductive paint to creative the conductive electrode surfaces. A wire carrying V+ was connected to the painted surface through the back of the device and attached using epoxy. The entire structure was then filled with high voltage epoxy dielectric which was subsequently cured. An initial ground plane was created using copper tape that only covered the electrode area of 4″×2″=8 in² on the top outside of the surface (not shown). The test article was tested by placing it onto a foam test stand that was connected using a high-tension string to a force meter (Omega® model DGF155-0.12). The test stand itself was hung from a structure using a string in a pendulum configuration. Any forces on the stand were monitored in real time. The applied voltage difference ΔV was supplied to the device as herein described using a high voltage power supply capable of providing up to +40 kVDC. The V−, or ground, side of the applied voltage difference ΔV from the power supply was connected to the copper tape. The force meter and power supplies were monitored using a LabView program.

Still referring to FIG. 21, other test configurations included replacing the foam test stand with a transparent box lined with ITO-coated PET film that was grounded. This eliminated Coulomb forces as well as ion wind forces. Forces on the box were monitored directly. Tests on the foam stand were repeated in both tension and compression mode by flipping the device 180 degrees to ensure there was no Coulomb attraction to the walls. Flipping the device ensures the forces are as described herein. Ion wind was prevented by placing the foam test stand inside a plastic bag.

Still referring to the test setup as depicted in FIG. 21, an example of the resulting force is shown in FIG. 22. The raw force is shown in red with 0.1 mN resolution. The thick dark red line is a smooth fit to the data. The black line is the applied DC voltage to the test device. Clearly there is a force in the positive direction (compression) when the voltage is applied. At +25 kV, the net average force for these two tests is approximately 237 μN. Similar tests to the one shown were repeated dozens of times. One striking verification of the theory was to increase the ground area to see if the force increased linearly. Increasing the ground area was performed by adding more copper tape to the back side which increased the surface area from 8 in² to 15 in² by coating the entire backside of the 3″×5″ area. Using the computational methods of the invention, this was expected to increase the force by approximately 1.8. Measurements after the application of copper tape to the full backside gave an average over several runs of 421 μN which is an increase of 1.77. Thus this test result correlated with the expected result, which was produced using the computational methods of the invention, very closely.

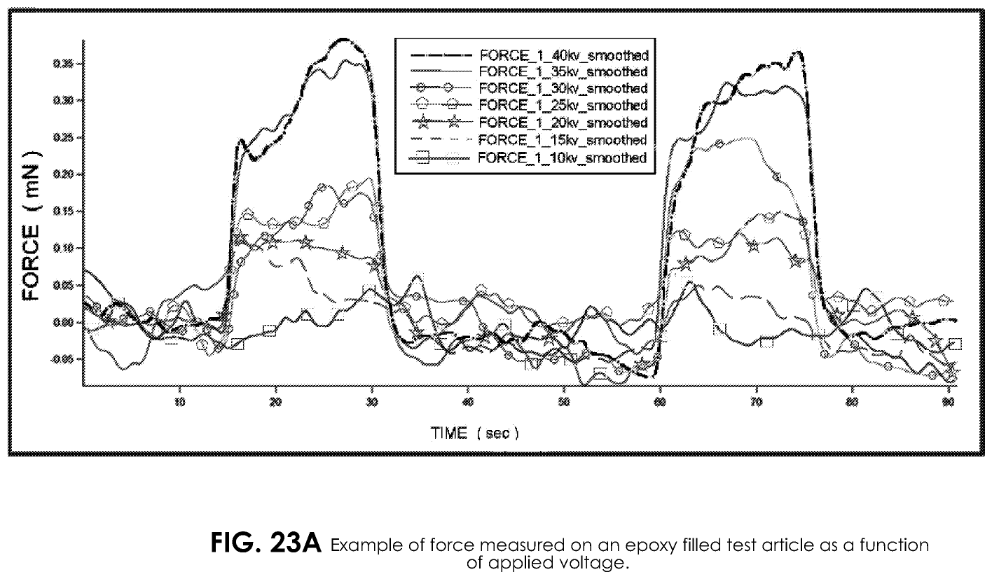

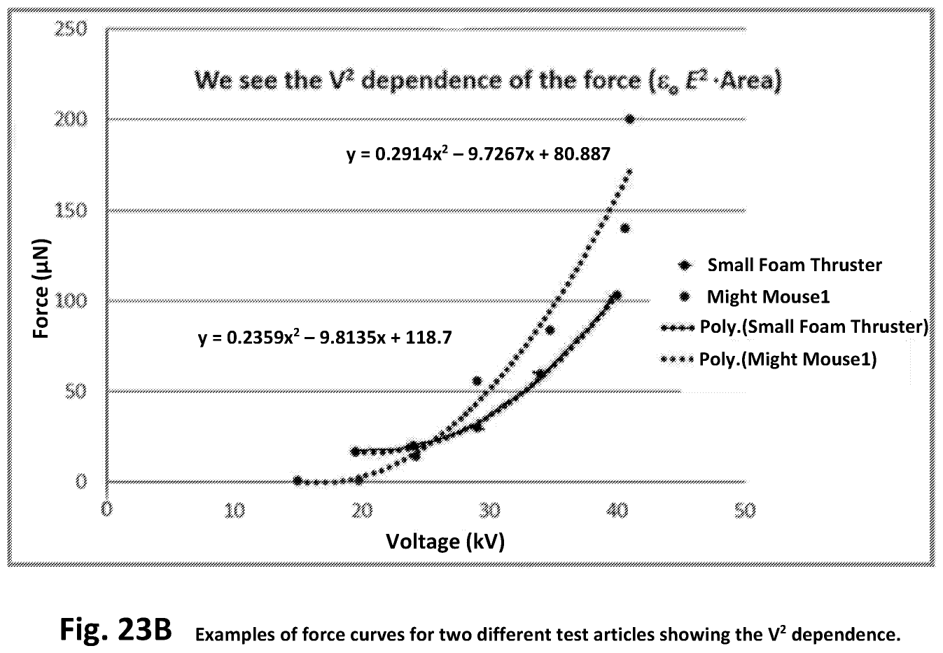

Several additional tests were shown to be consistent with the theory. The electrostatic pressure force has been shown to be a function of the square of the applied voltage difference. This was expected theoretically but is also observed experimentally (as well as computationally, using the computational method of the invention) as shown in FIG. 23A. Using this same test article, tests were performed at a variety of different voltages and the corresponding averages were measured.

Other test articles using a variety of different dielectrics 600, coatings, electrodes, and geometric arraignments of the electrically conductive surfaces were also shown to be consistent with the claimed invention. Test results for styrofoam EPF devices is shown in FIG. 23B. The force's squared dependence on voltage has been observed repeatedly over a variety of shape and geometries tested by the inventors.

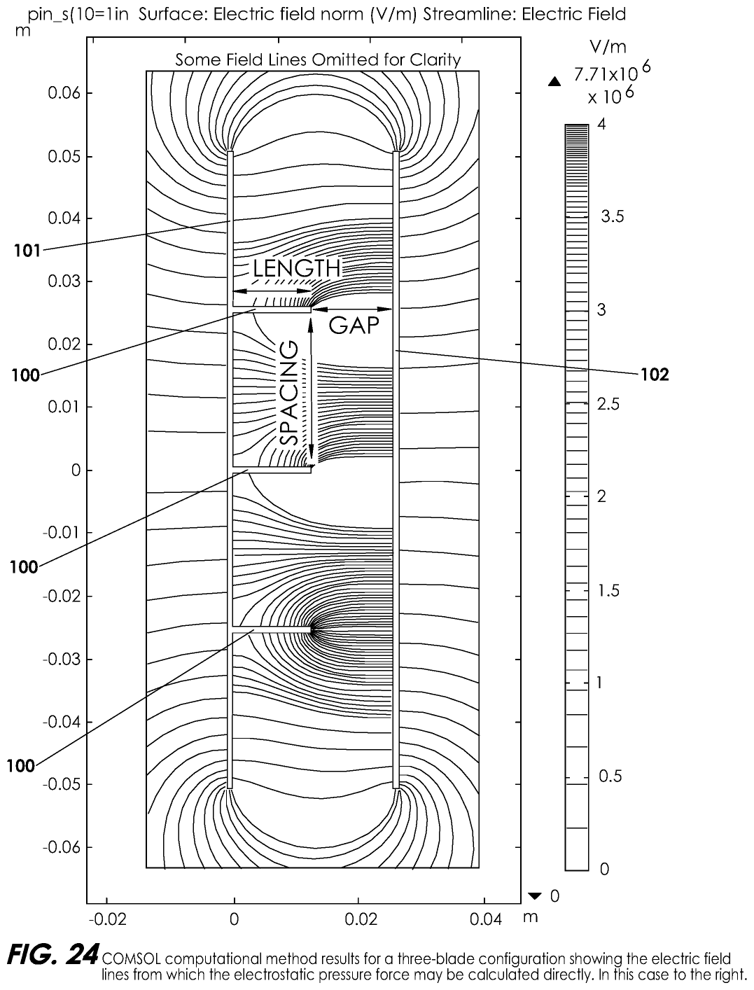

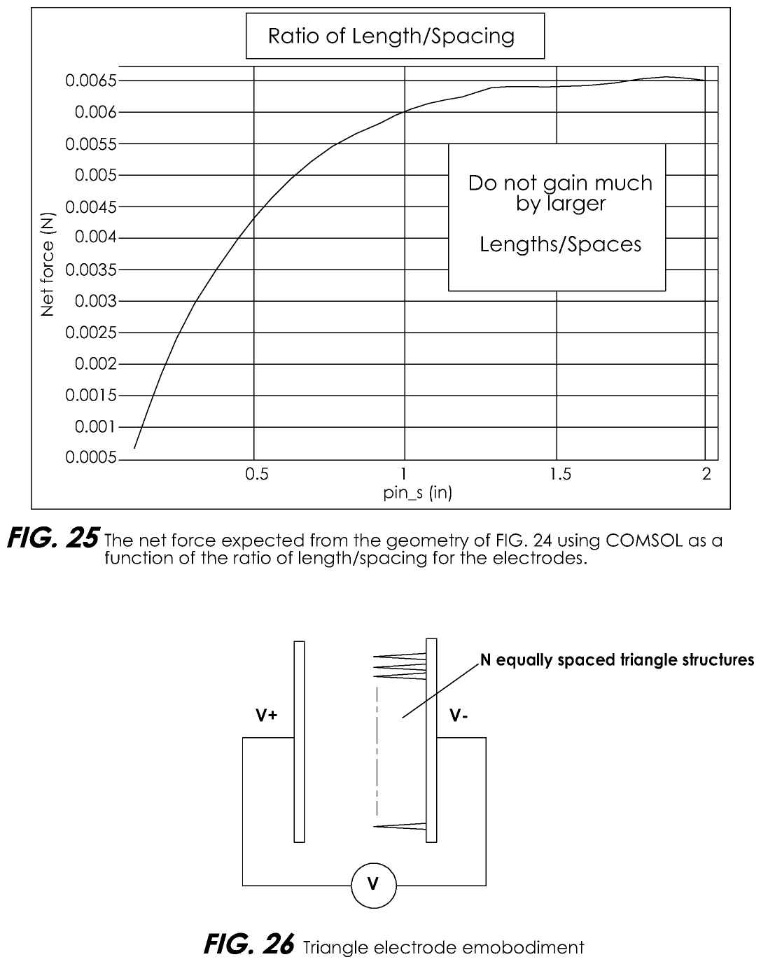

Referring now to FIG. 24, the invention may comprise a plurality of blades 100 which affect a larger area increasing, the net resulting electrostatic pressure force. The net resulting electrostatic pressure force grows as the number of blades 100 increases which affects a larger surface area on the ground plane depending on the spacing between blades 100, length of blades 100, the gap between electrodes, etc. There are many parameters of the geometric arrangement of the invention which may be optimized to achieve a desired net resulting electrostatic pressure using the computational methods of the invention.

Referring now to FIG. 25, it may be seen that COMSOL is a very useful tool for performing the computations required to achieve a desired net resulting electrostatic pressure force. For example, using such computational techniques, it is shown that there is little benefit in increasing the length of the blades 100 once it exceeds the spacing between the blades. There is little, or no, electric field reaching the electrode surface(s) 101a of electrode 101 which is Faraday shielded by the larger electrode blade 100, all at the same voltage.

Other aspects of the geometric arrangement of the electrostatic pressure force apparatus of the invention can be modeled by the computational techniques of the invention as well such as, for example, the thickness of the blades 100. As the blades get thicker, the area of them increases and the resulting pressure on the V+ side starts to compete with the pressure on the ground side. At some point, the pressure on the V+ side increases enough to overcome the EPF on the ground side and the force switches directions. Switching of the direction of the force based on the geometry alone has been observed by our team.

In any embodiment of the invention, gas breakdown can be prevented using an optional dielectric medium 600 in between the electrodes. The dielectric 600 can possess high dielectric strengths to reach local electric fields >10⁶ V/m depending on the dielectric used. Polyimide, PTFE, Styrofoam, epoxy, RTV and high voltage putty have all been used to increase the voltage on the electrodes limiting breakdown effects. For example, the test article of FIG. 23A was filled with high voltage epoxy while the test articles of FIG. 23B were filled with polyimide and foam. These are but some examples of the use of optional dielectric material 600.

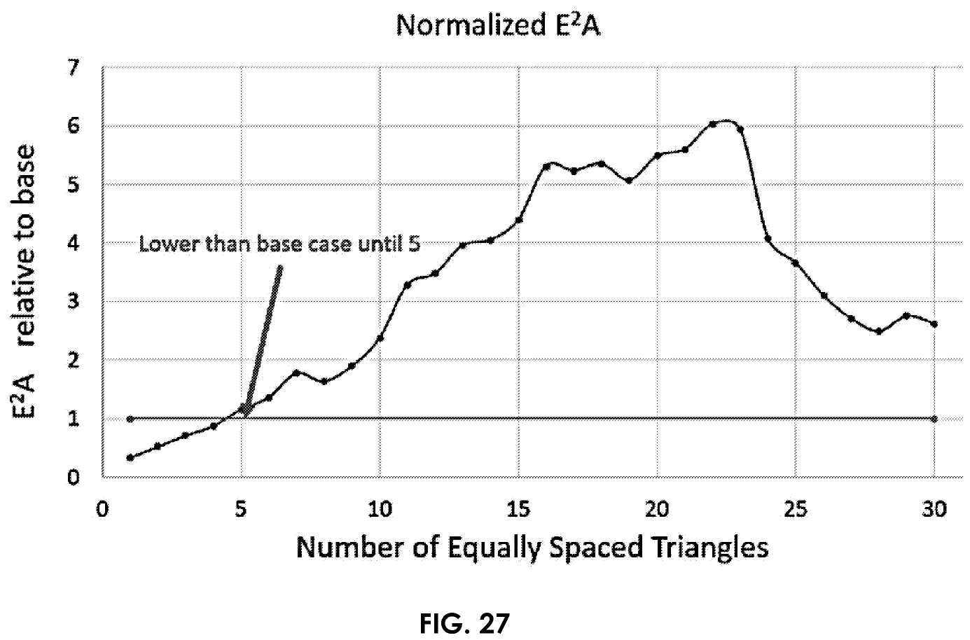

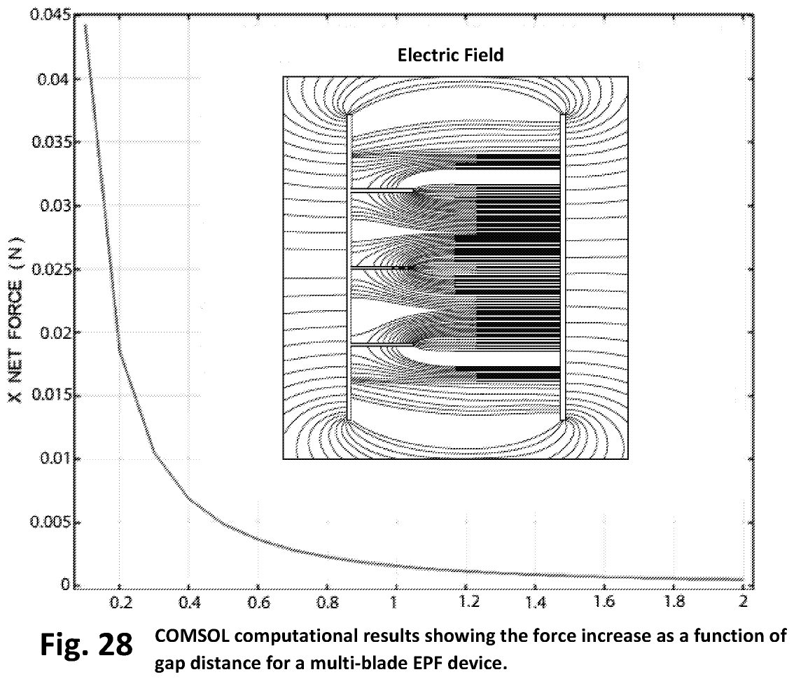

Referring now to FIGS. 26 and 27, in addition to optimizing the geometric arrangement of second electrode 102 and first electrode 101 by minimizing the pressure area product, one can easily maximize the pressure area product using the computational method of the invention. FIG. 26 shows a method for increasing the electrostatic pressure force for a constant non-time-varying electric field source. Here, the electric fields on the object surfaces were calculated using computation methods provided by a free software called FEMM (Finite Element Method Magnetics) for a given ground plane geometry. These field plus their geometry was given as input to MatLab (by MathWorks®) which calculated the electrostatic pressure force. Matlab can then be used to then generate a new script that can be read by FEMM, calculate the electric fields, and then again monitor the resulting pressure force in an optimization scheme. An example is shown in FIG. 26 using triangles as the chosen feature to provide an optimal ground which increases the effective area. An exemplary embodiment of the invention comprising a plurality of triangles disposed on electrode surface 102a is depicted in FIG. 26.

Referring now to FIG. 27, the results of this case show that as a flat electrode 102 is replaced with an electrode comprising triangular shapes features comprising electrically conductive surfaces, the electrostatic pressure force will initially be reduced for less than five such features. However, as the number of equally spaced triangles features is increased, the electrostatic pressure force increases and will eventually surpass the simple flat surface. As the number of triangles increases for the given area, the net electrostatic pressure force grows until a maximum at about 23 triangle features before the net electrostatic pressure force decreases. The benefit of the triangular V− electrode seems to suggest a factor of 6× in the strength available purely by geometrical arrangement considerations alone for a given potential. As the number of triangular electrode features grows larger, the benefit of the additional electrically conductive surface area is lost as the electric field can no longer penetrate into the grooves between the triangular features due to the Faraday shielding effect. Eventually, as the number approaches infinity, the force will be the same as the original flat plane as expected. We have also studied half circles, domes of various radii and other ground shapes for optimization purposes. This is an example of the computational techniques of the invention being used to develop a desired geometric arrangement of electrically conductive surfaces in order to achieve a desired net electrostatic pressure force.

### Embodiments Comprising Time Varying Applied Voltage

Then invention, in embodiments, may comprise an applied voltage difference that is a time-varying voltage difference. A more general solution to Equation (10) include this time dependence:

P(t)=Mv=εₒt[E₂²(t)A₂−E₁²(t)A₁] (12)

Equation (12) shows a non-linear time dependence of the momentum with a corresponding force given by:

$$F ( t ) = \frac{dP ( t )}{dt} = {ε}_{o} t [ 2 {E}_{2} \frac{d {E}_{2}}{dt} {A}_{2} - 2 {E}_{1} \frac{d {E}_{1}}{dt} {A}_{1} ] + {ε}_{o} [ {E}_{2}^{2} ( t ) {A}_{2} - {E}_{1}^{2} ( t ) {A}_{1} ] \qquad ( 13 )$$

Several non-limiting, exemplary cases of a time dependent force are now discussed. The most common case would be that of a sinusoidal time dependence such that E(t)=Csin(ωt+φ). We note that

$$\frac{dE ( t )}{dt} = C ω cos ( ω t + φ ) \qquad ( 14 )$$

$$tE ( t ) \frac{dE ( t )}{dt} = C {ω}^{2} t sin ( ω t + φ ) cos ( ω t + φ ) \qquad ( 15 )$$

The average of (15) is non-zero with the extra factor of time t over a full period. The second term is identical to Equation (11) and has a nonzero average as well. For a phase shift of zero, the time dependent part (15) is negative and subtracts from the overall force. Interestingly, the force would be greatly enhanced if the phase shift p is nonzero and the two terms would add to a greater force. For example, with an amplitude of 100 V/m, the second term averages to be C₂/2=5000 (V/m)². With a zero phase shift, the contribution for the time dependent term (15) is −2500 giving a total amount of 2500. On the other hand, if there's a phase shift of 90°, then the time dependent term is +2500 giving a net of 7500 (V/m)². In general, the force scales as C₂/2 and is either increased or decreased by an amount C₂/4 depending on the phase of the signal.

It is important to note that a frequency component of the time varying applied voltage plays no part in the resulting net electrostatic pressure force. Analysis of the average of the above terms shows that the frequency component cancels out. The amplitude component however, remains and thus the net electrostatic pressure force is strongly correlated to the square of the amplitude.

There are other time-dependent terms that can be utilized such as exponential decays, hyperbolic decays as well as square waves, triangle waveforms, etc. As to which is the best form to use we do not know at this time. Experimentally square waves work best but that is most likely due to overshoot since it is impossible to achieve changes in the high and low state instantaneously which would require infinite bandwidth. Such transients are known to give stronger forces [see Woodwards' MET] but their affects tend to cancel on the opposite cycle.

Thus, the applied voltage difference ΔV between opposing electrodes, in any embodiment, may comprise a time varying voltage difference that is independent of frequency.

### Scalability

Referring now to FIG. 28, the ultimate goal is to have a nanoscale version of this thrust technology. FIG. 28 shows a COMSOL computational result of the force as a function of gap distance for a three-bladed EPF device (figure insert). As one moves the ground closer to the electrodes the force increases as expected for a given voltage. As long as electrical breakdown is prevented, the blade electrodes and the ground can be as close as possible.

There is no reason as to why systems comprising embodiments of the invention cannot be made on the nanoscale. The technology already exists to generate small vertical arrays called field emission arrays (FEAs). These FEAs are used for not only for television displays and related devices, they are also used for Field Emission Electric Propulsion (FEEP). FEEP rely on strong electric fields to accelerate atomic ions from the surface of a metal (cathode) toward a grounded plate. A replacement for current FEAs is the use of carbon nanotubes (CNT) which are more robust and possess superior electrical properties. CNTs can be made to conform not only to the geometries of FEAs but also small nanowires at the microscopic scales.

In further embodiments, the invention may comprise nanostructures. Referring now to FIG. 29, in further embodiments of the invention, known fabrication techniques may be utilized to fabricate any physical embodiment of the invention that comprises a first electrode with at least one proximal electrode surface 100a, at least one structure 700, and, in embodiments, a plurality of structures 700, for disposing proximal electrically conductive surface 100a a distance from distal electrically conductive surface 101a, and at least one opposing electrode surface 102a (not shown in FIG. 29) as hereinbefore described. The exterior surfaces of structure 700, which may extend from electrically conductive surface 101a to proximal electrically conductive surfaces 100a, may be at least partially electrically conductive such that proximal electrically conductive surfaces 100a are in electrical contact with distal electrically conductive surface 101a. One such technology is demonstrated in FIG. 29 [Chiu 2006]. In this embodiment, wires made of several CNTs may be synthesized using chemical vapor deposition and grown vertically on an Si wafer array. The transfer of the CNTs onto a Al₂O₃ substrate preprinted with silver paste is shown in FIG. 29. The purpose of the research was to develop better CNTs with enhanced field emission properties. The result is that CNTs can be generated in a small parallel wire-like pattern on the microscopic scale. An embodiment of the present invention may comprise carbon nanotubes that, on a very small scale such as a nanoscale, may form the structure for supporting and forming at least one proximal electrode surface 100a, at least one distal electrode surface 101a, and at least one opposing electrode surface 102a as hereinbefore described, or, alternatively, such structures may be utilized to form unique electrode shapes for achieving any desired electrostatic pressure and resulting net electric force.

### Further Embodiments of the Claimed Invention

One exciting attribute is the possibility of making the electrodes and the ground system transparent. Indium Tin Oxide (ITO) used for touch screens, cell phones, etc. has widely been used a successful transparent conductor for decades. Since the EPF device does not require high currents, the lower resistivity of conventional non-transparent conductive materials such as copper, silver, gold, etc. is not necessary. Thus the entire EPF system can be made transparent similar to glass. One application of this technology would be to use it as a propulsive thrust for spacecraft as a glass cover on top of the required solar panels. The skin of a spacecraft can be used for station keeping or thrust maneuvers. This application will save volume and mass but also extends the life of the spacecraft which to date is solely limited by propellant availability.

In a traditional chemical or electric enhanced chemical rocket propulsion system the velocity added to the propulsive mass fraction comes from the heating of material or accelerating the mass fraction in some kind of electromagnetic field. In all cases, the propulsive mass fraction is expelled from the spacecraft. The change in velocity of the expelled mass times the propulsive mass fraction is the propulsive momentum available to be transferred to the spacecraft. Specifically, in chemical rocketry, the mass fraction acceleration energy comes from the breaking of high energy chemical bonds in the propellant. In ion/plasma chemical rocketry the delta velocity comes from accelerating ionized gas in an electromagnetic field. In solar sailing, low mass/high energy solar wind is collected on a massive scale to provide the physical momentum needed to accelerate the spacecraft. No matter the chemical or electrical enhancement, all rocket propulsion systems rely on action/reaction physics to achieve motion. To move the spacecraft, high velocity mass must transfer its physical momentum to the spacecraft prior to being ejected. EPF propulsion is not like these other forms of propulsion in that no mass is consumed or expelled in the conversion of Electromagnetic Potential into Physical Momentum. Electrical potential is converted into physical momentum via a unique application of electrostatic physics and unique reactor design.

In all classical or electrically-enhanced chemical rocketry propulsion systems, once the propellant is exhausted the propulsion system becomes useless. In all cases, the amount of energy that can be packed into the propellant is a function of how chemically or electrically unstable the material is. The trade between safety and economy tends to make spacecraft large and expensive with very small payload mass fractions. These propulsion systems all have life spans and efficiencies that are directly dependent on the propellant they consume. Once the propellant is exhausted, the propulsion system shuts down and its mass fraction of the spacecraft becomes waste. The mass fraction of the space vehicle devoted to conventional chemical or electrical/chemical propulsion including fuel, oxidizer, storage tanks, pumps, rocket motors, and structure to hold all this together is upwards of 98% of the total mass of the spacecraft. Unique to EPF propulsion, the mass fraction devoted to propulsion can be as little as 2% of the total mass of the spacecraft. As no mass is consumed or expelled in the production of thrust, no spacecraft mass fraction need be reserved for propulsion. As the propulsion system need never be turned off, the mass fraction dedicated to making thrust is never wasted.

In direct contrast to chemical rocketry, an EPF propulsion system does not require any fuel or oxidizer or mechanical systems or propellant mass to be consumed or expelled in any way. EPF creates physical momentum from stored electrical energy in a hermetically sealed reactor, and over time, that created physical momentum is realized as physical force. The spacecraft is accelerated by the application of this physical force. As no mass fraction of the spacecraft is expended to create thrust, the lifespan of the EPF thruster, and thereby the spacecraft housing them, are near limitless. Realistic mass fractions of the spacecraft devoted to propulsion could be as little as 2% of the total mass of the spacecraft. This projected low mass fraction is in direct contrast to the 98% mass fractions currently accepted for chemical/electric spacecraft propulsion systems. Low propulsion mass fraction, very high efficiency, and never having to turn off the propulsion will bring about a revolution in the exploration of space. Travel times to the planets will be measured in days as opposed to months/years. Greater mass fractions of the spacecraft will be used for the payloads.

In chemical/electric rocketry propulsion, the physical momentum available to the spacecraft is limited by the exit velocity of the expelled mass. All chemical/electric forms of spacecraft propulsion are limited to accelerating the expelled mass at some small fraction of the speed of light. As a result of this restriction, the maximum velocity any chemical rocket propulsion system can achieve is a very small fraction of the speed of light. EPF propulsion does not require the expulsion of mass to transfer physical momentum and therefore has the capability of propelling a spacecraft to a significant fraction of the speed of light.

In embodiments, the invention may comprise any element or feature described herein, in any quantity and in any combination, and in any order. The embodiments depicted in the figures and described herein are exemplary in nature and not intended to limit the invention.

In general, the invention may comprise any number of electrodes, disposed on any number of bodies, in any configuration, with applied voltage(s), such as may be determined to achieve a desired net resulting electrostatic pressure force or forces acting the body or plurality of bodies.

In any embodiment, the voltage differences between the electrodes may be time-varying, non-time-varying, or any combination thereof as between the electrodes.

In any embodiment of the invention, the net resulting electrostatic pressure force may be characterized as being the vector sum of all electrostatic pressure forces acting on the object, and the net resulting electrostatic pressure force may be characterized as a vector. In the figures, the axis along which a net resulting electrostatic pressure force acts may be depicted as the x axis of a three-dimensional coordinate system for convenience. However, the coordinate axis and physical configuration of the electrodes (i.e. the conductive surfaces) and any dielectric material depicted in the figures are merely exemplary. A user or designer of a system implementing the inventive schemes disclosed and claimed herein may elect to utilize any three-dimensional coordinate system orientation, any electrode size or three dimensional shape, any arrangement or spatial configuration of electrodes or dielectric materials, and any application of voltage to any electrode they choose in order to achieve a desired result, for example a desired net resulting force on an object. Any net resulting electrostatic pressure force or net resulting volumetric DIV-E force (described below), or resulting force that is a combination of the two, may act in any direction and magnitude desired as may be predetermined and implemented by computational techniques, and, further, any resulting force does not necessarily need to align with any particular axis of a three-dimensional coordinate system.

In embodiments, the invention may achieve not only asymmetrical electrostatic pressure forces, or EPF, but may also achieve an additional force termed the “Divergence in E-field” or “DIV-E” force(s) as described below.

The theory defining the generation of DIV-E forces of embodiments of the invention is now described.

The present invention makes use of conservation of energy for a system or an object, such as, for example, a center-of-mass (CM) system or object, in which the total energy (kinetic energy plus potential energy) is zero. The kinetic energy of a system may be comprised of an object with mass M, velocity v with potential energy U is written, setting the total energy to zero, as:

$$0 = \frac{1}{2} M {v}^{2} + U \qquad ( 1 )$$

What follows is a method to determine the conservation of momentum where one solves for momentum to give:

$$M v = - \frac{2}{v} U \qquad ( 2 )$$

Now we turn the velocity in the denominator of (2) into its operator

$$v = \frac{d x}{dt}$$

to give

$$M v = - \frac{2 Udt}{d x} . \qquad ( 3 )$$

The next step is to note that d(Ut)=Udt+tdU and solve for Udt=d(Ut)−tdU. The differential of the product of energy and time is akin to the differential of the energy-time action integral S=∫L dt of the Lagrangian. Nature chooses the path of least action which is found by setting the differential to zero δS=δ∫Ldt=0. Here the invention utilizes the the concept that that the differential of the energy-time product should also be set to zero d(Ut)=S(Ut)=0 meaning:

Udt=−tdU (4)

Putting this back in to Equation (3) results in:

$$M v = + 2 t \frac{d U}{d x} \qquad ( 5 )$$

It is understood that force, generally, is the time rate of change of momentum and is also the spatial derivative of energy with distance.

The next step is to fill in the potential energy of the system. Conventionally one would use an external field as a source of the potential. However, the invention uses a more generic form of energy, the energy stored in the electric field. In particular, the energy stored in the electric field is given by

$$U = \frac{{ε}_{o}}{2} \int {E}^{2} d τ \qquad ( 6 )$$

where ∫dτ is the integral over the volume. The placement of Equation (6) into Equation (5) along the x direction gives:

$$M v = {ε}_{o} t \frac{d}{d x} \int \int \int {E}^{2} d x d ydz . \qquad ( 7 )$$

An important aspect of the derivative is noting that it operates on both the electric field squared and the volume elements via the chain rule. Thus:

$$M v = {ε}_{o} t [ d ( \int \int {E}^{2} d y d z ) + \int \int \int dxdydz \frac{d}{d x} {E}^{2} ] \qquad ( 8 )$$

$$Mv = {ε}_{o} t [ Δ ( {E}^{2} A ) + 2 V E \frac{d E}{d x} ] \qquad ( 9 )$$

which can be written as:

P(t)=Mv=εₒt[(E₂²A₂−E₁²A₁)+2VE∇E] (10)

Equation (10) shows a linear time dependence on the momentum with a corresponding force of:

$$F = \frac{d P}{dt} = {ε}_{o} [ ( {E}_{2}^{2} {A}_{2} - {E}_{1}^{2} {A}_{1} ) + 2 V E ∇ E ] \qquad ( 11 )$$

if the electric field between the electrodes does not have a time dependence (i.e., if the electric field between the electrodes is electrostatic). Thus, it is a discovery and inventive concept for the structure claimed that the resulting force contains a surface effect (first term of Equation 11) as well as a volumetric effect (second term of Equation 11). The term εₒE² is the electrostatic pressure on the surface. This pressure, when applied to an area, results in a force; and, if there is an uneven, or asymmetric, amount of electrostatic pressure on the two opposing surfaces of the electrodes, the system will experience a net force on its center of mass.

Additionally, the second term is a volumetric force on the system, and is present provided there is a divergence in the electric field within the volume between the electrodes. Thus, we refer to the surface effects (first term of Equation 11) as the electrostatic pressure force (EPF) while the volumetric effect (second term of equation 11) is referred to as the “divergence in E-field force” (also may be referred to as “divergent electric field force” or “DIV-E” force). A DIV-E force is experienced on an object in the case in which the electric field (“E-field”) between the electrodes of the object is characterized as having a non-zero divergence; i.e., when the electric field between the electrodes is divergent. The DIV-E field may be caused to be divergent, if, for example, a plurality of dielectric materials having differing permittivities are disposed in the electric field between the electrodes. In embodiments, these dielectric materials may be disposed in the gap, or volume, between the electrodes where they are within the electric field which may be created by the application of voltages of different levels to the electrodes, or may be an externally applied electric field from man-made or natural sources. The divergence in E-field force, or DIV-E, force may be characterized as volumetric because it operates on all points of the three-dimensional volume of the dielectric materials subject to the divergent electric field.

The permittivity of free space εₒ is 8.85×10⁻¹² F/m and the maximum allowed electric field in air before breakdown is ˜10⁶ V/m. This gives an electrostatic pressure on the order of ˜1 Pa or one Pascal. Since air is approximately 101.3 kPa, electrostatic pressure is about five orders of magnitude less. It is important to note that electrostatic pressure is not necessarily the force or pressure due to Coulomb attraction on a surface. For example, if one surface is positive and the other surface is negative, there will be a strong force of attraction between both surfaces which is on the order of ˜kq₁ q₂/r² where

$$k = \frac{1}{4 π {ε}_{o}} = 9 \times 1 {0}^{9} N {m}^{2} {C}^{- 2} .$$

The Coulomb force may be resisted by a structure, which may be a non-conductive or electrically isolating structure, disposed between the electrodes that prevents the electrodes from collapsing together. The resulting net effect of the Coulomb forces on the object is therefore zero.

Although the electric field may be well defined in the region between the two surfaces and consists of a known direction, the electrostatic pressure force is not directionally dependent; rather, it is a function of the square of the electric field. Thus, the two surfaces will have a strong force of attraction between the two surfaces due to the Coulomb coupling constant, but, at the same time, the electrostatic pressure between the two surfaces will push the two surfaces away from each other, albeit a much weaker force due than the Coulomb force due to the electrostatic pressure force being linearly dependent on the free space permittivity constant while Coulomb's constant is inversely proportional to that same constant. However, and importantly, the electrostatic pressure forces on the object may be asymmetrical.

One of the discoveries made in the present invention is that this asymmetry of the electrostatic pressure results in a net electrostatic pressure force on a system or object comprising the apparatus of the invention. This may be accomplished by maximizing the force on one electrode surface and minimizing the force on another electrode surface. Usually the high voltage electrode surface experiences minimized electrostatic pressure while the ground, or negative voltage electrode surface, experiences the maximum amount of electrostatic pressure. It is not important which surface is which.

Additionally, the second term of Equation 11 shows that a net divergence in E-field force on an object can be generated internally provided that a divergent electric field exists in the volume between the electrodes, and at least one dielectric material is disposed within the divergent electric field. This can be a microscopic electric field or a macroscopic one, and may be achieved, for example, by the placement of one or more dielectric materials, such as dielectric material layers, having differing permittivities, in the volume or gap between electrodes, in the electric field between the electrodes of the invention. For example, if the size, three-dimensional shapes, and geometric arrangements of the electrodes establish a divergent electric field, or if the electrodes are placed within an externally applied electric filed, one or more dielectric materials may be disposed in the electric field, giving rise to a volumetric divergence in E-field force acting on the dielectric materials.

In another example, a first dielectric material having a first permittivity, and a second dielectric material having a second permittivity, may be placed in the electric field between the electrodes. Because the first dielectric material and the second dielectric material have different permittivities, a divergent electric field is established between the first and second electrodes, resulting in a net divergent electric field (DIV-E) force acting on the dielectric materials. When the dielectric materials are attached to a structure that also is attached to the electrodes, such as an object body structure, the net DIV-E force acting on the dielectric materials also acts on the object body, and could be used, for example, as a motivating force. This arrangement may be extended to any configuration and any number of electrodes, and any configuration and any number of dielectric materials have differing permittivities. Thus the number and configuration of electrodes; the voltage level of applied excitation voltages to the electrodes, and the number, configuration, and selection of permittivity of the dielectric material(s) placed in the electric field, may be selected and configured to achieve a desired resulting net divergence in E-field force (DIV-E force) on an object comprising the apparatus of the invention.

A non-limiting example of the net resulting electrostatic pressure force was experimentally observed in the case where, at +25 kV voltage difference between electrodes, the net average force on the test sample was approximately 237 μN. Similar tests were repeated dozens of times by the inventors. One striking verification of the theory was to increase the surface area of the V− electrode to determine whether the resulting electrostatic pressure force increased linearly. Increasing the surface area of the V− electrode was performed by adding more copper tape to the electrode which increased the surface area from 8 in² to 15 in² by covering the entire backside of the 3 inch×5 inch area with a conductive surface. In accordance with the theory of the invention, this increase in the V− electrode area was expected to increase the resulting electrostatic pressure force by a factor of approximately 1.8. Measurements after the application of copper tape to the full backside of the V− electrode resulted in an average measured resulting electrostatic pressure force over several runs of 421 μN which is an increase of 1.77, very close to the expected theoretical result. Thus, the theoretical prediction of net force on an object using the structure and method of the invention has been verified by experimental results.

As but one example of selection of electrode characteristics to achieve a desired effect, the inventors experimented with maximizing the surface electrode area on one side while minimizing the electrode areas on the other side. This has shown experimentally to produce the EPF consistent with the theory. The force has been shown to be a function of the square of the applied voltage as well as linearly proportional to the surface area.

The presence of the divergence in E-field force (DIV-E) force was also verified by testing. These tests involved changing the dielectric material in the electric field which allows the divergence of the field to play a stronger role in the force which in some cases creates the force in the opposite direction consistent with the theory. Hundreds of other test articles were devised in order to test and verify both the electrostatic pressure force as well as the divergence in e-field DIV-E force.

The divergent electric field (DIV-E) force(s) may be achieved by the use of materials, which may include but not be limited to metamaterials, having differing values of permittivity placed in the E-field between conductors of the system. A series of materials, including but not limited to metamaterials, may be placed in an arrangement between the electrodes as shown in non-limiting, exemplary fashion in FIG. 30. A first electrode 1000 may comprise a conductive surface 1003 which may comprise any electrically conductive material. First electrode 1000 may, for example, comprise any material or combination of materials that comprise an electrically conductive surface 1003 such as solid conductors, conductor-clad dielectric metamaterials, dielectric materials or other configurations or combinations of materials. Similarly, a second electrode 1001 may comprise a conductive surface 1006 which may comprise any electrically conductive material. Second electrode 1001, may, for example, comprise any material or combination of materials that comprise an electrically conductive surface such as solid conductors, conductor-clad dielectric metamaterials, dielectric materials or other configurations or combinations of materials. Electrodes 1000, which may have electric potential V+, and 1001, which may have electric potential V− which may be a different potential than V+, may be separated by a physical gap 1002, and one or a plurality of dielectric material layers or structures of differing permittivity may be located between conductive surface 1003 and conductive surface 1006. In the non-limiting, exemplary embodiment shown in FIG. 30, two dielectric materials of differing permittivity, namely, a first dielectric material 1004 having a first permittivity ε1, and a second dielectric material 1005 having a second permittivity ε2, are shown as being located between electrically conductive (electrode) surface 1003 and electrically conductive (electrode) surface 1006. The dielectric materials 1004 and 1005 may have differing thickness T1 and T2, respectively, and they may take any three-dimensional shape desired to achieve a specific net resulting DIV-E force 1011. Electrodes 1000 and 1001, and dielectric materials 1004 and 1005, may be fixed relative to one another by a structure 1007 which maybe electrically isolating, such that a DIV-E force 1010 acting on a dielectric material is translated to a net resulting DIV-E force 1011 acting on the apparatus, or object to which the apparatus is attached, tending to motive the object along a thrust vector or force 1011. In embodiments, the electric field may be generated by the application of V+ to electrically conductive (electrode) surface 1003, and the application of V− to electrically conductive (electrode) surface 1006. However, in embodiments, the electric field that gives rise to the volumetric DIV-E forces acting on first dielectric material 1004 having a first permittivity ε1, and a second dielectric material 1005 having a second permittivity ε2 may be generated or sourced by any external electric field source, which may be man-made or naturally occurring, or any combination of the two.

Conductive material selection, metamaterial property selection for electrostatic and physical properties, thickness of the various electrode elements, relative permittivity of the various elements and electrostatic properties of the gap medium all play a determining roll in the physical layout of the structure. A structure may be used to maintain the relative spacing of the components of the assembly while not facilitating or giving rise to the formation of unassociated electrostatic fields. Engineering trade-offs may be utilized determine the efficiency of the system with respect to thrust generation.

In still further embodiments of the system and method of the invention, the invention may comprise a plurality of embodiments of the apparatus depicted in FIG. 30 as shown in FIG. 31. A series of combinations of dielectric materials 1004 and 1005, and electrodes 1000 and 1001 which may have applied voltages V+ and V−, may be placed in an arrangement as seen in FIG. 31. An electrically conductive element, such as a metal clad dielectric metamaterial or a stand-alone metal surface may be shaped into a high voltage electrode 1000. Similarly, a second electrically conductive element, such as a metal clad dielectric metamaterial or a stand-alone metal surface may be shaped into a similar electrode 1001. Again, the electrodes may be separated by a physical gap 1002 as shown in FIG. 30. Thrust, i.e. force, on the object results from the summation of the resulting divergence in E-field (DIV-E) forces and electrostatic pressure forces on the conductive surfaces 1003 and 1006 (depicted in FIG. 30 for the singular case). Conductive material selection, metamaterial property selection for electrostatic and physical properties, thickness of the various electrode elements, relative permittivity of the various elements and electrostatic properties of the gap medium all play a determining roll in the physical layout of the structure. A structure such as structure 1007 as also depicted in FIG. 30 may be used to attach and maintain the relative spacing of the components of the assembly of electrodes 1000, 1001, 1004, and 1005 such that these elements are fixed relative to one another, while not encouraging the formation of unassociated electrostatic fields. Engineering trade-offs for specific applications of the system and method of the invention are used to determine the efficiency of the system with respect to thrust generation, for embodiments of the invention. The net force 1021 acting on the structure is the vector sum of all of the net resulting DIV-E forces 1011 from each of the “cells” depicted in FIG. 30. In other words, the structure of FIG. 31 may be a plurality of the structures shown in FIG. 30 combined in such a way as to produce a desired net force 1021. Again, the structures depicted in FIGS. 30 and 31 are exemplary. The scope of the claimed invention may comprise any geometric (three-dimensional) arrangement of electrodes and dielectric materials of any size, three-dimensional shape so as to achieve a desired net resulting DIV-E force, electrostatic pressure force, or any combination of net resulting DIV-E force and electrostatic pressure force, as determined, for example, by the use of computational techniques. Again, in embodiments, the electric field may be generated by the application of V+ to electrically conductive (electrode) surface 1003, and the application of V− to electrically conductive (electrode) surface 1006. However, in embodiments, the electric field that gives rise to the volumetric DIV-E forces acting on first dielectric material 1004 having a first permittivity ε1, and a second dielectric material 1005 having a second permittivity ε2, and also any resulting electrostatic pressure forces, may be generated or sourced by any external electric field source, which may be man-made or naturally occurring, or any combination of the two.

If the divergence in E-field force, or DIV-E, force is established using one or more dielectric materials in the electric field, the electric field magnitude(s) are reduced by the dielectric constant of the dielectric materials, and the overall force may be reduced accordingly. Interestingly, since the force is a function of the permittivity of the dielectric materials, one can tailor their effect by applying time-varying V+ and V− having a frequency component, since most dielectrics have strong frequency dependence. For example, at certain frequencies, the permittivity of one dielectric material could be low while the other dielectric material(s) could be high. Use can be made of the fact that the dielectric materials' permittivity may vary with frequency. By modulating the excitation frequency of applied voltages V+ and V−, changes in the resulting forces on the object may by achieved. Thus, frequency could be used as a way to steer the resulting force(s) on the object as forces decrease on one electrode and increase on another. If thrusters comprising the invention were oriented along difference axes of the object, the object could be steered in a desired direction in three-dimensional space by the modulation of frequency of the excitation voltages V+ and V− for the various thrusters.

There are other time-dependent terms that can be utilized such as exponential decays, hyperbolic decays as well as square waves, triangle waveforms, etc. Experimentally square waves work best but that is most likely due to overshoot since it is impossible to achieve changes in the high and low state instantaneously which would require infinite bandwidth. Such transients may produce stronger forces but their affects tend to cancel on the opposite cycle.

In embodiments, the inventive apparatus and method of the invention may comprise any number, size, three-dimensional shape, and arrangement of electrodes and dielectric materials to achieve one or more electrostatic pressure force(s), one or more divergence in E-field forces, or combinations of electrostatic pressure force(s) and divergence in E-field force (s) as may be desired. Computational methods may be utilized to determine the number, size, three-dimensional shape, and three-dimensional (i.e. geometric) arrangement of electrodes and dielectric materials to achieve one or more electrostatic pressure force(s), one or more divergence in E-field force, or combinations of electrostatic pressure force(s) and divergence in E-field force(s) as may be desired. The applied electrode voltages, or the external electric fields, may be time varying, and may be modulated in any manner, for example in frequency and in amplitude, to achieve desired more electrostatic pressure force(s), one or more divergence in E-field force, or combinations of electrostatic pressure force(s) and divergence in E-field force (s) in a system comprising a plurality of electrodes, which may also include a plurality of dielectric materials.

In an exemplary, non-limiting embodiment comprising two object surfaces, which may be but are not necessarily electrodes, within an divergent electric field, such as depicted in FIG. 30, the invention may comprise an apparatus for generating one or more forces, comprising: a electrode having a first electrically conductive surface; a second electrode having a second electrically conductive surface, disposed so as to form a gap between the first electrically conductive surface and the second electrically conductive surface; wherein a first voltage is applied to the first electrically conductive surface, and a second voltage is applied to the second electrically conductive surface, the first voltage and the second voltage being different voltages, causing the formation of an electric field in the gap between the first electrically conductive surface and the second electrically conductive surface. The invention may further comprise a first dielectric material layer having a first permittivity; and a second dielectric material layer having second permittivity; wherein the first electrode, second electrode, first dielectric material, second dielectric material are fixed in three-dimensional space relative to one another; and wherein the first dielectric material layer and the second dielectric material layer are disposed at least partially within the electric field; and wherein the presence of the first and second dielectric materials in the electric field give rise to a first volumetric divergence in E-field force on the first dielectric material, and a second divergence in E-field force acting on the second dielectric material, resulting in a net divergence in E-field force characterized as being the vector sum of the first and second divergence in E-field forces acting on said first and second dielectric materials, respectively. The electric field may also give rise to an electrostatic pressure acting on at least one surface of said object, thereby generating an electrostatic pressure force on said at least one surface of said object, wherein said electrostatic pressure force may be characterized by a net resulting electrostatic pressure force acting on said object. The resulting net divergence in E-field force and net resulting electrostatic pressure force may each be characterized by a vector determined by the selection of one or more of 1) the three-dimensional size and shape of each of the first and second conductive surfaces; 2) the geometric three-dimensional arrangement of each of the first and second conductive surfaces; 3) the value of each of the first and second applied voltages; 4) the permittivities of each of the first and second dielectric materials; and 5) the size, shape and geometric arrangement each of first and second dielectric materials. The net force acting on the apparatus may be defined as the vector sum of the net resulting electrostatic pressure force (EPF) and net divergence in E-field force (DIV-E force).

In an exemplary, non-limiting embodiment comprising a plurality of object surfaces, which may be but are not necessarily electrodes, within a divergent electric field, such as depicted in FIG. 31, the invention may comprise: a plurality of electrically conductive surfaces, each of the electrically conductive surfaces electrically isolated from one another; wherein each of the electrically conductive surfaces receives a different applied voltage, thus creating a voltage difference as between the electrically conductive surfaces and giving rise to a resulting electric field; a plurality of dielectric materials disposed in the resulting electric field, wherein each dielectric material of said plurality of dielectric materials is characterized by a different permittivity, causing the resulting electric field to be divergent, thereby generating a volumetric divergence in E-field force acting on the plurality of dielectric materials, resulting in a net resulting divergence in E-field force acting on the object. The electric field may also give rise to an electrostatic pressure acting on at least one electrically conductive surface of said plurality of electrically conductive surfaces, thereby generating an electrostatic pressure force acing on said at least one electrically conductive surface of said object; and wherein the electrostatic pressure force may be characterized by a net resulting electrostatic pressure force acting on the object that is the vector sum of all electrostatic pressure forces acting on said electrically conductive surfaces of said object. The net force acting on the object may be characterized by a vector determined by the selection of one or more of 1) the three-dimensional size and shape of each conductive surface of the plurality of conductive surfaces; 2) the geometric three-dimensional arrangement of conductive surface of each of the plurality of conductive surfaces; 3) the value of each applied voltages applied to each conductive surface of the plurality of conductive surfaces; 4) the permittivity of each dielectric material of the plurality dielectric materials; and 5) the size, shape and geometric arrangement of each dielectric material of the plurality of dielectric materials. The net force acting on the object is defined as the vector sum of the net resulting electrostatic pressure force and net divergence in E-field force.

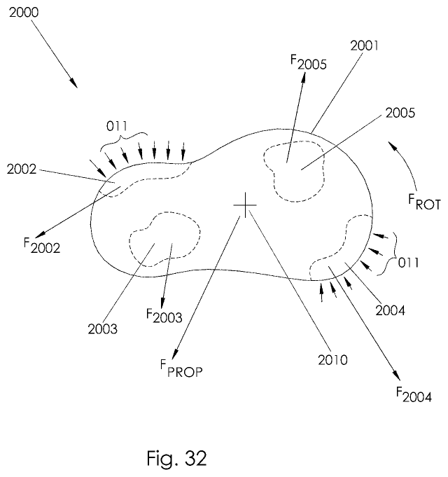

Having described various specific embodiments of the invention, it is possible now to define a basic, non-limiting, set of principles of the invention with aid of the depiction of an embodiment of the invention shown in FIG. 32. The invention is a system and method for generating a force on an object 2000, which may be any of the exemplary objects 500, 001, 002, 005, 006 as depicted in FIGS. 1, 3, 9, 13, and 17, respectively, which are specific, exemplary, non-limiting embodiments of apparatus' of the invention, which are depicted in basic, generic form as object 2000 in FIG. 32 for purposes of illustrating the basic principles of the invention. Object 2000 may be of any size or three-dimensional shape such that, when its surfaces are acted upon by one or more EPFs, or when its interior volume contains dielectric materials in a divergent electric field giving rise to DIV_E force(s), or both, one or more desired net resulting electrostatic pressures forces acting on object 2000 result. Object 2000 may comprise one more surfaces, such as surfaces 2002, 2003, 2004 or 2005, wherein an electric field acts on the surfaces. The electric field acting on each surface may arise from electric charge deposited or developed on that surface, or may be an externally generated natural or man-made electric field, or both. In the example shown in FIG. 32, the application of the electric field to the surfaces of the object may give rise to an electrostatic pressure 011 acting on the surfaces, thereby generating an electro-static pressure force (EPF) on each of the surfaces such as force F₂₀₀₂ acting on surface 2002, F₂₀₀₃ acting on surface 2003, F₂₀₀₄ acting on surface 2004, and F₂₀₀₅ acting on surface 2005. The electrostatic pressure forces acting on the surfaces may be characterized by one or more net resulting electrostatic pressure force(s) acting on the object 2000 that are the vector sum of the electrostatic pressure forces acting on the surfaces. In the non-limiting example shown in FIG. 32, two net resulting electrostatic pressure forces are shown: one, F_{PROP}, acts through center of mass 2010, and is thus a propelling force on object 2000. The other, F_{ROT}, acts offset from center of mass 2010, and thus imparts a rotating force F_{ROT} on object 2000. Thus, the at least one net resulting electrostatic pressure force may comprise a propelling force and one or more rotating forces acting on the object. The surface of object 2000 may be continuous, discontinuous, contain any number of surfaces of any area size, subject to different electric fields, may comprise any material composition such as electrically conductive, electrically non-conductive, or otherwise.

Still referring to FIG. 32, the object 2000 may comprise any number of surfaces such as surfaces 2002, 2003, 2004 or 2005. The surfaces of object 2000 may be of any size, or any shape, or any three-dimensional arrangement so as to achieve one or more desired net resulting forces acting on the object 2000. Each of the surfaces 2002, 2003, 2004 or 2005 may experience an electrostatic pressure force F₂₀₀₂, F₂₀₀₃, F₂₀₀₄, and F₂₀₀₅ that is proportional to the magnitude of the electric field applied to each surface; the electrostatic pressure force acting on the surfaces having a vector such as that may also be determined by the three-dimensional shape and area size of the surface 2002, 2003, 2004 or 2005. The vector sum of each of the electrostatic pressure forces on each of the surfaces and/or regions may result in at least one net resulting electrostatic pressure force acting on the object 2000.

Still referring to FIG. 32, the at least one net resulting force acting on the object 2000 is the vector sum of the Electrostatic Pressure Force(s) acting on each surface 2002, 2003, 2004 and 2005 of object 2000. The surfaces may comprise the outer surface of object 2000. Each surface of object 2000 may, or may not, comprise regions. Some or all of the surfaces 2002, 2003, 2004 and 2005, and the optional regions within a surface, may, or may not, be in electrical communication with one another, as determined by a user to achieve at least one desired net resulting force acting on the object. For example, if it were desired by a user to apply a uniformly distributed electric charge across two surfaces, the user may elect to electrically connect those two surfaces in order to achieve a uniform electric charge distribution across them. On the other hand, in a case in which the user desires to achieve a first electric charge per unit area on a first surface, and a second electric charge per unit area on a second surface, where the first electric charge per unit area and the second electric charge per unit area are not equal, the user may elect to electrically isolate the first surface from the second surface. And so on, for any number of surfaces and any number of regions with the surfaces of the object.

Still referring to FIG. 32, the magnitude and direction of the electrostatic pressure forces F₂₀₀₂, F₂₀₀₃, F₂₀₀₄, and F₂₀₀₅ acting on any surface or region 2002, 2003, 2004 or 2005 of the invention may be achieved by determining one or more parameters, in any combination, selected from the group consisting of. 1) the amount of electric charge on the surface or region; 2) the magnitude and direction of any electric field acting on the surface or region; 3) the three-dimensional shape of the surface or region; or 4) the size of the surface or region. The foregoing parameters may be determined in any combination, and in any order. Thus these parameters may be determined by the user, in accordance with the inventive principles set forth herein, such that at least one desired electrostatic pressure force acting on a surface or region of the invention is achieved, and when the object comprises a plurality of surfaces or regions of surfaces such as 2002, 2003, 2004 or 2005, at least one net resulting force acting on the object is achieved. In the embodiment depicted in FIG. 32, two net resulting electrostatic pressure forces F_{PROP} and F_{ROT} are produced. In this specific example, the object 2000 can be propelled (motivated) and steered (rotated) by, for example and not by way of limitation, controlling the magnitude of the electric field applied to one or more surfaces 2002, 2003, 2004 or 2005 of object 2000, controlling the amount of electric charge on one or more surfaces 2002, 2003, 2004 or 2005 of object 2000, controlling the area size or the shape, or both, of one or more surfaces 2002, 2003, 2004 or 2005 of object 2000, or by controlling the three-dimensional arrangement of, and placement of, surfaces 2002, 2003, 2004 or 2005 so that when the EPF acting on the surfaces are vector summed, at least one desired net resulting EPF is achieved.

In embodiments, it is not necessary that the at least one electric charge be evenly distributed across all surfaces, or regions of surfaces, of the object. Said another way, there may be one or more surfaces or regions of the surface(s) of the object that comprise an electric charge having a first value, one or more surfaces of regions of the surface(s) of the object that comprise an electrical charge having a second value, one or more surfaces or regions of the surface(s) of the object that comprise an electrical charge having a third value, for any number of regions, and any number of difference electrical charges or electric fields applied the regions. It is not necessary that all surfaces or regions of the surface(s) of the object have a non-zero value of electrical charge (such regions may have zero electric charge). Surfaces, or regions surfaces, of the object that have different values of electric charge may have any value, of gradation of electric charge at the boundaries between them as may be determined by the user, so as to achieve any desired net force(s) acting on the object, in accordance with the inventive principles described herein.

In embodiments, it is not necessary that the surfaces of the object be electrically conductive. In other words, in any of the embodiments, the surfaces of the object may or may not be electrically conductive. The surfaces of the object may, for example, comprise any material or combination of materials, which may include electrically conductive materials such, for example metals, electrically insulating materials, dielectric materials or any other material compositions. Further, the material composition of the object does not necessarily need to be homogenous across all surfaces of the object. Thus, surfaces and regions of the object may comprise electrically conductive or non-electrically conductive surfaces, in any size or shape, in any combination or order, as may be determined by the user to achieve any desired net resulting force(s) acting on the object, in accordance with the inventive principles described herein.

In embodiments, the invention may comprise an apparatus for generating a force, comprising a first electrode having a first electrically conductive surface; a second electrode having a second electrically conductive surface, disposed so as to form a gap between the first electrically conductive surface and the second electrically conductive surface; and at least one dielectric material; wherein the first electrode, the second electrode and the at least one dielectric material are disposed at least partially in a divergent electric field and are fixed in three-dimensional space relative to one another; and wherein the divergent electric field establishes a volumetric divergence in E-field (DIV-E) force acting on the at least one dielectric material. The resulting net divergence in E-field force may be characterized by a vector determined by the selection of one or more of 1) the three-dimensional size and shape of each of the first and second conductive surfaces; 2) the geometric three-dimensional arrangement of each of the first and second conductive surfaces; 3) the value of each of the first and second applied voltages; 4) the permittivity of the dielectric materials; and 5) the size, shape and geometric arrangement each of the dielectric material. The at least one dielectric material may further be defined as a plurality of dielectric materials, each dielectric material of the plurality of dielectric materials having a different permittivity than the other dielectric materials of the plurality of dielectric materials.

In embodiments, the invention may comprise an apparatus for generating a force, comprising an electric field; a first electrode having a first electrically conductive surface; a second electrode having a second electrically conductive surface, disposed so as to form a gap between the first electrically conductive surface and the second electrically conductive surface; a first dielectric material layer having a first permittivity; and a second dielectric material layer having second permittivity; wherein the first electrode, second electrode, first dielectric material, second dielectric material are fixed in three-dimensional space relative to one another, for example via a structure attaching the first electrode, second electrode, first dielectric material, second dielectric material together; and wherein the first electrically conductive surface, second electrically conductive surface, first dielectric material layer and the second dielectric material layer are each disposed at least partially within the electric field; and wherein first dielectric material layer and the second dielectric material layer cause the electric field to be divergent, resulting in an asymmetry of electrostatic pressure forces on said first electrically conductive surface and said second electrically conductive surface, resulting in a non-zero net electrostatic pressure force on said apparatus. The resulting net electrostatic pressure force may be characterized by a vector determined by the selection of one or more of 1) the three-dimensional size and shape of each of the first and second conductive surfaces; 2) the geometric three-dimensional arrangement of each of the first and second conductive surfaces; 3) the value of each of the first and second applied voltages; 4) the permittivities of each of the first and second dielectric materials; and 5) the size, shape and geometric arrangement each of first and second dielectric materials. The electric field may be generated by application of a first voltage applied to the first electrically conductive surface, and a second voltage applied to the second electrically conductive surface, said first voltage and said second voltage being different voltages, causing the formation of the electric field. Alternatively, the electric field may be an external electric field such as a man-made electric field or naturally occurring electric field.

In embodiments, the electric field may be generated by application of differing voltages and/or polarities (i.e. the depositing of electrical charges) to the surfaces of the object, which surfaces may be but are not necessarily electrodes. In alternate embodiments, the electric field is not generated by the application of voltages to the surfaces electrodes, but is rather generated by an external electric field such as a man-made electric field or naturally occurring electric field. And, in embodiments, the electric field may be a combination of an electric field generated by application of differing electric charges to the surfaces of the object and one or more external electric fields such as a man-made electric field or naturally occurring electric fields, in any combination.

In embodiments, the invention may comprise a method for generating a force on an object, comprising the steps of providing a plurality of electrically conductive surfaces, each of the electrically conductive surfaces electrically isolated from one another; providing an electric field that may be generated by application of differing voltages to at least two the electrically conductive surfaces or providing an external man-made or naturally occurring electric field, or both; and providing a plurality of dielectric materials disposed in the resulting electric field in a gap between the electrically conductive surfaces, wherein each dielectric material of said plurality of dielectric materials is characterized by a different permittivity, causing the resulting electric field to be divergent, thereby generating a volumetric divergence in E-field force acting on the plurality of dielectric materials, resulting in a divergent electric field and also resulting in a net resulting divergence in E-field force acting on said object. The divergent electric field may also give rise to an asymmetric electrostatic pressure acting on at least two electrically conductive surfaces of the plurality of electrically conductive surfaces, thereby generating asymmetric electrostatic pressure forces acing on the at least two electrically conductive surface of the object; and wherein the asymmetric electrostatic pressure forces may be characterized by a net resulting electrostatic pressure force acting on said object that is the non-zero vector sum of all electrostatic pressure forces acting on the electrically conductive surfaces of the object, such that a net force acting on the object is defined as the vector sum of the net resulting electrostatic pressure force and net divergence in E-field (DIV-E) force.

The method of the invention may also comprise the step of using a computational method to determine the size, three-dimensional shape and three-dimensional arrangement of said plurality of electrically conductive surfaces so as to achieve a desired net resulting electrostatic pressure force acting on said object; wherein the computational method comprises the steps of:
a. defining a size, three-dimensional shape and three-dimensional arrangement of each of the electrically conductive surfaces;
b. determining the electric field intensity at each point along said electrically conductive surfaces;
c. determining the resulting electrostatic pressure force acting on surfaces of said object;
d. summing, in vector fashion, all resulting electrostatic pressure forces acting on each of said surfaces of said object to determine a computed total net resulting electrostatic pressure force acting on said object;
e. comparing said computed total net resulting electrostatic pressure force to a desired net resulting electrostatic pressure force for acting on said object; and
f. iteratively changing the size, three-dimensional shape and geometric arrangement of each of the electrically conductive surfaces or the value of the at least one voltage and repeating steps a.-e. until the desired net resulting electrostatic pressure force acting on said object is achieved.

In embodiments, the voltages applied to the electrodes to establish the electric field may be time varying or electrostatic. If the electric field is externally applied such as by any man-made or environmental source, the electric field may be time-varying or may be electrostatic.

In embodiments, the conductive surfaces of the electrodes may be any size, three-dimensional shape, or number. While the figures of the drawings depict generally planar shapes, this is for convenience of illustration only. The conductive surfaces of the electrodes may be any three-dimensional shape, including shapes having curvilinear cross sections, and shapes defined has having more than one curvilinear cross section (i.e. compound curvilinear shapes).

In embodiments, any surface or region of a surface that comprises (i.e., carries) an electric charge may have such electric charge deposited or developed on such surface or region of a surface by any means, such as, for example, and not by way of limitation, surface electrical charging by ion implantation (wherein ions of an element are accelerated into such surface), surface electrical charging by ultraviolet light irradiation, surface electrical charging by tribocharging using the triboelectric effect, surface electrical charging by corona spray charging, direct electrical contact with a source of electric charge, or any other means known or unknown in the art for depositing or developing an electric charge on a surface.

In the various embodiments of the invention, a surface or region of a surface of the invention may be identified herein as having a voltage. As used herein, this term includes within its meaning a surface that carries an electric charge. Thus, when a surface or region of a surface is defined as having a voltage, such as V+ or V−, such surface or region of a surface is also defined as carrying an electric charge. The electric charge may be deposited or developed on the surface by any of the means disclosed herein or by any means known in the art. Further, the descriptions of an applied voltage or charge to any surface may herein be shown, for exemplary purposes only, as positive or negative, “V+” or “V−” and so on, but such depiction of polarity is only by way of example, and not by way of limitation. The embodiments of the invention include all combinations of positive and negative applied voltage or electric charge to any of the surfaces of the object, as may be determined by a user to result in a resulting desired net force on the object using the inventive concepts of the invention. Thus the invention is not to be limited only to the polarities depicted in the figures or discussed in the written description.

Embodiments of the invention may comprise an apparatus and method that is configured according to the inventive principles set forth herein such that an object may be subject to one or more electrostatic pressure forces, one or more DIV-E forces, or any combination of one or more electrostatic pressure forces and one or more DIV-E forces.

We claim:

1. An apparatus for generating a force, comprising:
an object having at least one surface, wherein said at least one surface is subject to an electric field;
wherein the electric field acting on the at least one surface gives rise to an electrostatic pressure acting on the at least one surface;
wherein the electrostatic pressure acting on the at least one surface gives rise to an electrostatic pressure force acting on the least one surface;
wherein the magnitude and direction of the electrostatic pressure force acting on the at least one surface is determined by one or more parameters selected from the group consisting of 1) the magnitude and direction of the electric field acting on the surface or region; 2) the three-dimensional shape of the surface; and 3) the size of the surface;
wherein the one or more parameters are determined so as to produce a desired at least one net electrostatic pressure force acting on the object.

2. The apparatus for generating a force of claim 1, wherein the at least one surface is further defined as comprising an electrically conductive material composition.

3. The apparatus for generating a force of claim 1, wherein the at least one surface is further defined as comprising a dielectric material composition.

4. The apparatus for generating a force of claim 1, wherein the electric field is externally applied.

5. The apparatus for generating a force of claim 1, wherein the electric field arises from a presence of electric charge present on said at least one surface.

6. The apparatus for generating a force of claim 1, wherein the electric field is a net electric field that is the sum of 1) an externally applied electric field, and 2) an electric field arising from the presence of electric charge present on said at least one surface.

7. The apparatus for generating a force of claim 1, wherein the magnitude of the electric field is time-varying.

8. The apparatus for generating a force of claim 1, wherein the object is further defined as having a center of mass, and wherein the at least one net electrostatic pressure force acting on the object is characterized by a vector acting through the center of mass, establishing a propelling force on the object.

9. The apparatus for generating a force of claim 1, wherein the object is further defined as having a center of mass, and wherein the at least one net electrostatic pressure force acting on the object is characterized by a vector acting on the object offset from the center of mass, establishing a rotating force on the object.

10. The apparatus for generating a force of claim 1, wherein the at least one surface is further defined as a plurality of surfaces, each surface of the plurality of surfaces subject to an electrostatic pressure acting on the surface, giving rise to an electrostatic pressure force acting on the surface, and wherein the net resulting electrostatic pressure force acting on the object is the vector sum of the electrostatic pressure force acting on each surface comprising the plurality of surfaces.

11. The apparatus for generating a force of claim 10, wherein each surface of the plurality of surfaces is defined as comprising an electrically conductive material composition.

12. The apparatus for generating a force of claim 10, wherein each surface of the plurality of surfaces is defined as comprising a dielectric material composition.

13. The apparatus for generating a force of claim 10, wherein the applied electric field acting on each surface of the plurality of surfaces is externally applied.

14. The apparatus for generating a force of claim 13, wherein the magnitude and direction of the applied electric field acting on each surface of the plurality of surfaces is determined independently of each of the other surfaces comprising the plurality of surfaces.

15. The apparatus for generating a force of claim 10, wherein at least a portion of the applied electric field acting on each surface of the plurality of surfaces arises from a presence of electric charge present on each surface.

16. The apparatus for generating a force of claim 15, wherein the amount of the electric charge present on each surface of the plurality of surfaces is determined independently of each of the other surfaces comprising the plurality of surfaces.

17. The apparatus for generating a force of claim 10, wherein the applied electric field acting on each surface of the plurality of surfaces is a net electric field that arises from the sum of 1) an externally applied electric field acting on each surface of the plurality of surfaces, and 2) an electric field arising from the presence of electric charge present on each surface.

18. The apparatus for generating a force of claim 10, wherein the object is further defined as having a center of mass, and wherein the at least one net electrostatic pressure force acting on the object is characterized by a vector acting through the center of mass, establishing a propelling force on the object.

19. The apparatus for generating a force of claim 10, wherein the object is further defined as having a center of mass, and wherein the at least one net electrostatic pressure force acting on the object is characterized by a vector acting on the object offset from the center of mass, establishing a rotating force on the object.

20. A system for motivating a structure, comprising:
at plurality of apparatuses for generating a force, each apparatus comprising:
at least one object having at least one surface, wherein said at least one surface is subject to an electric field;
wherein the electric field acting on the at least one surface gives rise to an electrostatic pressure acting on the at least one surface;
wherein the electrostatic pressure acting on the at least one surface gives rise to an electrostatic pressure force acting on the least one surface;
wherein the magnitude and direction of the electrostatic pressure force acting on the at least one surface is determined by one or more parameters selected from the group consisting of 1) the magnitude and direction of the electric field acting on the surface or region; 2) the three-dimensional shape of the surface; and 3) the size of the surface;
wherein the one or more parameters are determined so as to produce a desired at least one net electrostatic pressure force acting on the object;
wherein each apparatus comprising the plurality of apparatuses is attached either directly or indirectly to a structure to be motivated;
wherein at least one resulting motivating force is applied to the structure, the at least one motivating force being the vector sum of all of the at least one net electrostatic pressure forces acting on the surfaces of the apparatuses.

21. The system for motivating a structure of claim 20, wherein the magnitude of each electric field acting each surface of the at least one surface of the apparatuses is controllable so as to achieve a desired electrostatic pressure force acting on each surface, such that the at least one motivating force is controllable in magnitude and direction.

22. The system of motivating a structure of claim 20, wherein the magnitude of each electric field acting each surface of the at least one surface of the apparatuses is controllable so as to be time-varying.

23. The system for motivating a structure of claim 20, wherein at least one surface of the at least one surface of each object is further defined as comprising an electrically conductive material composition.

24. The system for motivating a structure of claim 20, wherein at least one surface of the at least one surface of each object is further defined as comprising a dielectric material composition.

25. The system for motivating a structure of claim 20, wherein the electric field acting on each surface of the at least one surface of each object is externally applied.

26. The system for motivating a structure of claim 20, wherein at least of portion of the electric field acting on each surface of the at least one surface of each object arises from a presence of electric charge present on the at least one surface.

27. The system for motivating a structure of claim 20, wherein the structure has a center of mass, and wherein the resulting motivating force acting on the structure is characterized by a vector acting through the center of mass, establishing a propelling force on the structure.

28. The apparatus for generating a force of claim 19, wherein the structure has a center of mass, and wherein the resulting motivating force acting on the structure is characterized by a vector acting on the structure offset from the center of mass, establishing a rotating force on the structure.

29. The apparatus for generating a force of claim 20, wherein the magnitude and direction of the at least one resulting motivating force applied to the structure is determined by the three-dimensional spatial arrangement of the apparatuses.

30. An apparatus for generating a force, comprising:
a structure comprising a configuration of dielectric material disposed in an electric field, wherein the configuration of dielectric material is characterized as having a volume;
wherein the electric field with the volume a divergent electric field;
and wherein the divergent electric field within the volume acting on the configuration of dielectric material gives rise to a net divergent electric field force acting volumetrically on the configuration of dielectric material; and
wherein the configuration of dielectric material and the structure are adapted to transfer the net divergent electric force to the structure.

31. The apparatus of claim 30, wherein the configuration of dielectric material is a solid material composition.

32. The apparatus of claim 31, wherein the configuration of dielectric material is fixedly attached to the structure.

33. The apparatus of claim 30, wherein the configuration of dielectric material comprises a plurality of individual dielectric materials, each individual dielectric materials having a different permittivity than the other individual dielectric materials; and wherein the divergence of the electric field within the volume is caused at least in part by the effect of the difference in permittivity of the individual dielectric materials on the electric field.

34. An apparatus for generating a force, comprising:
an object having at least one surface, wherein said at least one surface is subject to an electric field;
wherein the electric field acting on the at least one surface gives rise to an electrostatic pressure acting on the at least one surface;
wherein the electrostatic pressure acting on the at least one surface gives rise to an electrostatic pressure force acting on the least one surface;
wherein the magnitude and direction of the electrostatic pressure force acting on the at least one surface is determined by one or more parameters selected from the group consisting of 1) the magnitude and direction of the electric field acting on the surface;
2) the three-dimensional shape of the surface; and 3) the size of the surface;
wherein the one or more parameters are determined so as to produce a desired at least one net electrostatic pressure force acting on the object; and
wherein said object further comprises a configuration of dielectric material disposed in a divergent electric field;
wherein the divergent electric field acting on the configuration of dielectric material gives rise to a net divergent electric field force acting volumetrically on the configuration of dielectric material; and
wherein the configuration of dielectric material and the structure are adapted to transfer the net divergent electric force to the object, such that a total net force acting on the object is the vector sum of the at least one net electrostatic pressure force acting on the object and the net divergent electric force acting on the object.
